(19) United States
(12) Patent Application Publication
(10) Pub. No.: US 2011/0207522 A1
(43) Pub. Date: Aug. 25, 2011

(54) DEVICE, SYSTEM, AND METHOD OF AUTOMATIC ONLINE GAMING

(76) Inventors: Itai Girafi, Ramat Gan (IL); Roy Samouelov, Tel Aviv (IL); Ido Raviv, Ramat Efal (IL)

(21) Appl. No.: 12/995,729

(22) PCT Filed: Jun. 1, 2009
(86) PCT No.: PCT/IL2009/000541

§ 371 Date: Apr. 28, 2011

Related U.S. Application Data
(60) Provisional application No. 61/129,054, filed on Jun. 2, 2008.
(60) Provisional application No. 61/146,355, filed on Jan. 22, 2009.

(51) Int. Cl. A63F 13/00

(52) U.S. Cl. 463/22

(57) ABSTRACT

Some embodiments relate to online gaming. For example, a side-game application corresponding to an online indicia-based game may receive player-indicia information representing player indicia already dealt to a player, prior to the dealing of at least one un-dealt indicia; based at least on the player-indicia information, to automatically determine one or more player-specific side-game scenarios, each defining a criterion relating to one or more of the un-dealt indicia; to automatically offer to the player a side-game including the one or more scenarios; to receive at least one wager from the player corresponding to at least one respective wagered scenario; and, upon a dealing of the un-dealt indicia of the wagered scenario, to automatically reward the player if the criterion corresponding to the wagered scenario is met.

### CROSS REFERENCE

This application claims the benefit of and priority from U.S. Provisional Patent application 61/129,054, entitled “Method of gaming over the internet”, filed Jun. 2, 2008, and U.S. Provisional Patent application 61/146,355, entitled “Device, system, and method of online gaming”, filed Jan. 22, 2009, the entire disclosures of both of which are incorporated herein by reference.

### FIELD

Some embodiments relate generally to the field of online gaming in general and, more particularly, to automatically generating one or more side-games associated with an online game.

### BACKGROUND

Various online games, for example, online card games, may include one or more turns, rounds, sessions, and the like (commonly referred to as “rounds”).

In one example, the Texas Hold'em Poker card game may be played by a plurality of players “seated”, physically or virtually, with a game operator (“dealer”), around a “table”.

The Texas Hold'em Poker game may include dealing two player cards, also known as “hole cards”, to each player and five community cards, which are revealed to all players. The hand of each player is determined by using the best five cards of the seven cards available to the user, using any suitable combination of the two hole cards and the five community cards. The player having the best hand may win a total of wagers (“bets”) placed by the players (“the pot”).

The Texas Hold'em game may include four betting rounds. In order to continue to play the game each player may be required to act on each of the betting rounds.

A first round may be performed prior to dealing cards to the players. For example, two blinds (referred to as “the small blind” and “the big blind”) may be placed in the pot by two players to the immediate left of the dealer (indicated by a dealer “button”).

A first dealing round may include dealing to each player of the game two player cards out of a deck of 52 cards.

A “pre-flop” betting round may take place after the dealing round. For example, the player located to the left of the big blind may select to either “fold”, e.g., by quitting the game, thereby loosing the amount betted by the player; “call”, e.g., to match a betted amount placed in the pot; or to “raise”, e.g., by increasing the betted amount in the pot. All other players may make this selection, according to turn, e.g., in a clockwise manner.

Following the betting round, a round named “the flop” commences by having the dealer reveal three community cards. After the flop round, a second betting round may take place, in which the remaining players, which did not “fold” (“the active players”) may “call”, “raise”, or “fold”, e.g., beginning with the player to the left of the button.

Following the second betting round, a round named “the turn” commences by revealing a fourth community card. After the turn round, a third betting round may take place, in which the remaining active players may “call”, “raise”, or “fold”.

Following the third betting round, a round named “the river” commences by dealing a fifth and final community card. After the river round, a fourth betting round may take place, in which the remaining active players may “call”, “raise”, or “fold”.

Eventually, a total of five community cards will be revealed. The Active players can use any combination of the community cards and their own two hole cards to form the best possible five-card poker hand.

A player, which has “folded” during one or more of the betting rounds of the game, may not be allowed to further participate in the following rounds of the game, and may be allowed to participate only in a new game, e.g., after the game has ended.

One of the biggest setbacks of online games, for example, online card games, e.g., online Texas Hold'em poker, is a period of inactivity and/or retention of a player during the game, e.g., if the payer has “folded” during one or more of the betting rounds. Numerous turns may be left un-wagered by the player, causing the player to be left “outside” of the game, rather than play the game. From a player's perspective, the “inactive” time, during which the player is not actively participating in the game, may affect the player's game experience. From the game-operator's perspective, game commissions are not maximized or even lost during the “inactive” time; and/or the player may be bored and even quit the game and/or switch to another game or operator.

### SUMMARY

Some embodiments include, for example, devices, systems, and methods of automatic online gaming.

In some embodiments a system may include a memory having stored thereon side-game application instructions; and a processor to execute the side-game application instructions resulting in a side-game application corresponding to an online indicia-based game, the indicia-based game including dealing a first number, equal to or greater than one, of player indicia to each of one or more players and dealing a second number, equal to or greater than one, of community indicia revealed to all of the players; wherein the side-game application is to receive player-indicia information representing player indicia already dealt to a player of the players, prior to the dealing of at least one un-dealt indicia, wherein the at least one un-dealt indicia includes at least one of a player indicia to be dealt to the player and a community indicia to be revealed to the players; wherein, based at least on the player-indicia information, the side-game application is to automatically determine one or more player-specific side-game scenarios, each defining a winning criterion relating to one or more of the un-dealt indicia, and to automatically offer to the player a side-game including the one or more player-specific side-game scenarios; wherein the side-game application is to receive at least one wager from the player corresponding to at least one respective wagered side-game scenario of the one or more scenarios; and wherein, upon a dealing of the un-dealt indicia of the wagered scenario, the side-game application is to automatically reward the player if the criterion corresponding to the wagered scenario is met.

In some embodiments, the one or more side-game scenarios include a player-specific insurance scenario, which is based on the player-specific information, and wherein the un-dealt indicia include one or more community indicia to be dealt after all the player indicia are dealt.

In some embodiments, the criterion of the insurance scenario requires that the un-dealt indicia, when dealt, will include indicia resulting in a first expected winning probability associated with a first combination of the player indicia and community indicia after dealing the un-dealt indicia, wherein the first expected winning probability is lesser than a second expected winning probability associated with a second combination of the player indicia and community indicia prior to dealing the un-dealt indicia.

In some embodiments, the one or more side-game scenarios include a post-withdrawal scenario to be automatically offered to the player if the player withdraws from the game prior to dealing the un-dealt indicia, wherein the criterion of the post-withdrawal side-game scenario relates to the one or more un-dealt indicia.

In some embodiments, the un-dealt indicia include one or more community indicia to be dealt after all player indicia have been dealt.

In some embodiments, the winning criterion of the post-withdrawal scenario requires that, after dealing the one or more un-dealt indicia, the community indicia will form together with the player indicia, a predefined winning indicia combination.

In some embodiments, the side-game application includes a scenario definer to automatically define the one or more player-specific side-game scenarios based on the player-specific information; and a reward-ratio definer to automatically determine, based on the player-specific information, one or more player-specific reward ratios corresponding to the one or more scenarios, respectively, each reward ratio defining a ratio between the reward and the wager corresponding to the scenario, wherein the side-game application is to automatically provide the one or more winning ratios to the player in association with the one or more scenarios, respectively, and to reward the player based on the wining ratio.

In some embodiments, the reward-ratio definer is to determine the reward ratio corresponding to a scenario based on an expected probability of the un-dealt indicia meeting the criterion of the scenario.

In some embodiments, the un-dealt indicia include only one or more community indicia to be dealt after all player indicia have been dealt.

In some embodiments, the indicia-based game includes a card game.

In some embodiments, the card game includes a poker game.

In some embodiments, the poker game may include a Texas hold'em poker game.

In some embodiments, the first number of player indicia includes at least two player cards.

In some embodiments, the second number of community indicia includes five community cards, which are revealed during two or more rounds.

Some embodiments a system, which includes a memory having stored thereon side-game application instructions; and a processor to execute the side-game application instructions resulting in a side-game application corresponding to an online indicia-based game, the indicia-based game including dealing one or more player indicia to each of one or more players; wherein, prior to a dealing of at least one un-dealt player indicia, the side-game application is to automatically determine one or more side-game scenarios, each defining a winning criterion relating to one or more of the un-dealt player indicia, and to automatically offer to a player of the players a side-game including the one or more player-specific side-game scenarios; wherein the side-game application is to receive at least one wager from the player corresponding to at least one respective wagered side-game scenario of the one or more scenarios; and wherein, upon a dealing of the un-dealt indicia of the wagered scenario, the side-game application is to automatically reward the player if the criterion corresponding to the wagered scenario is met.

In some embodiments, the side-game application is to offer the one or more scenarios prior to dealing any player indicia.

In some embodiments, the player indicia include at least two player cards.

In some embodiments, the side-game application is to offer the one or more scenarios prior to dealing any of the two player cards, wherein the one or more scenarios include one or more respective winning combinations of the two player cards.

In some embodiments, the player includes a player of a currently played game, and wherein the one or more player-specific side-game scenarios relate to un-dealt player indicia to be dealt to the player in a successive game.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system in accordance with some demonstrative embodiments.

FIGS. 2-5 are schematic block diagram illustrations of interface components offering side-game scenarios, in accordance with a demonstrative embodiment.

FIGS. 6-8 are schematic block diagram illustrations of interface components offering side game scenarios, in accordance with another demonstrative embodiment.

FIGS. 9-14 are schematic block diagram illustrations of interface components offering side game scenarios, in accordance with another demonstrative embodiment.

FIGS. 15-19 are schematic block diagram illustrations of interface components offering side game scenarios, in accordance with yet another demonstrative embodiment.

FIGS. 20-21 are schematic block diagram illustrations of interface components offering side game scenarios, in accordance with yet another demonstrative embodiment.

FIG. 22 is a schematic block-diagram illustration of a method of determining one or more insurance side-game scenarios, in accordance with some demonstrative embodiments.

FIG. 23 is a schematic block-diagram illustration of a method of determining one or more post-withdrawal side-game scenarios, in accordance with some demonstrative embodiments.

FIG. 24 is a schematic block-diagram illustration of a method of determining one or more general side-game scenarios, in accordance with some demonstrative embodiments.

FIG. 25 is a schematic block-diagram illustration of a method of determining a reward ratio corresponding to a side-game scenario, in accordance with some demonstrative embodiments.

FIG. 26 is a schematic block-diagram illustration of a method of offering a player-card side-game scenario, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein include, for example, “multiple” or “two or more”. For example, “a plurality of items” includes two or more items.

Some embodiments may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a non-mobile or non-portable device, a wireless communication station, a wireless communication device, a wireless Access Point (AP), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.11a, 802.11b, 802.11e, 802.11 g, 802.11h, 802.11i, 802.11n, 802.16, 802.16d, 802.16e standards and/or future versions and/or derivatives and/or Long Term Evolution (LTE) of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, a wired or wireless handheld device (e.g., BlackBerry, Palm Treo), a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth®, Global Positioning System (GPS), Wi-Fi, Wi-Max, ZigBee™, Global System for Mobile communication (GSM), 2G, 2.5G, 3G, 3.5G, or the like. Some embodiments may be used in various other devices, systems and/or networks.

At an overview, some embodiments may be implemented, for example, as part of and/or in addition to an online indicia-based game, e.g., an online card game.

Some embodiments may include a side-game service or application (“the side-game application”) capable of automatically generating, and/or offering to a player of the online indicia-based game, a player-specific or player-customized side-game on top of, and/or in addition to, the online game.

In some embodiments, the player-specific side-game may include one or more player-specific side-game scenarios based one or more player-specific indicia associated with the player. For example, in a card game, the player-specific side-game scenarios may be based on one or more player cards dealt to the player. In one example, in the Texas Hold'em poker game, the player-specific side-game may be based on the hole cards of the player, e.g., such that two players of the same game, having different hole cards, may be offered with two different side-game scenarios, respectively.

In some embodiments, the side-game application may offer the player to place a wager or bet (“to wager”) on one or more side-game scenarios, and award the player if a predefined criterion of a wagered scenario is met.

In some embodiments, a player specific side-game scenario may define a winning criterion relating to one or more indicia to be dealt in the game (“the un-dealt indicia”). For example, the criterion may define the identity of one or more of the un-dealt indicia, e.g., a color, type and/or value of one or more of the un-dealt indicia; and/or a reward ratio (also referred to as the “winning ratio”) defining a reward ratio between a reward to be provided, if a wager is placed on the scenario and the un-dealt indicia meet the criterion, and the wager.

In some embodiments, the side-game application may enable the player of the online game to wager or bet “against the house”, thereby hedging an actual wager or bet of the player in the online game. In other embodiments, the side-game scenarios are not limited only for hedging, and may be used to provide any other suitable side-game to the player.

Some embodiments may be implemented by an online gaming service to allow a participant of an online game, e.g., an online Texas Hold'em poker game, to play one or more side-games in addition to, or instead of, playing the online game. As a result, the player may participate in more turns of the game, employing his attention and helping to contribute to a rake of an operator of the online game. This may result in an increase in the contribution to a rake commission of the operator, while not compromising, for example, the course or logic of the online game.

Some embodiments include a side-game application to automatically provide a player-specific side-game to a participant in an online game, for example, an online card game, for example, an online poker game, e.g., an online Texas-Hold'em Poker game.

In some embodiments, the player-specific side game may offer the player to place side-wagers or “side-bets” on the game by placing bets or wagers on one or more side games, which are tailored and/or customized to the specific status of the player in the game, e.g., as described in detail below.

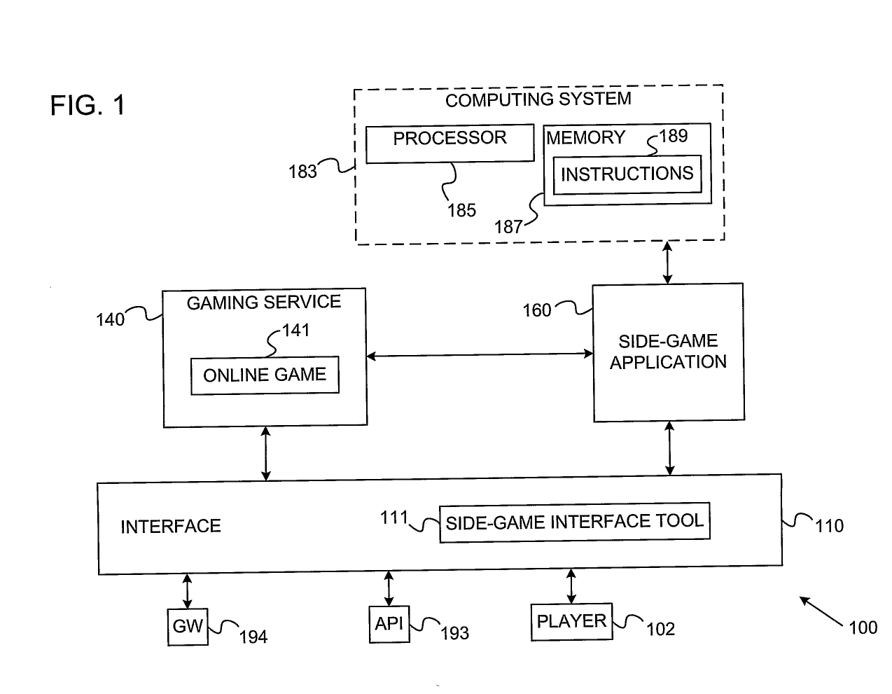

Reference is now made to FIG. 1, which schematically illustrates a block diagram of a system 100 in accordance with some demonstrative embodiments.

In some embodiments, system 100 includes one or more user (“player”) stations or devices 102, for example, a PC, a desktop computer, a mobile computer, a laptop computer, a notebook computer, a tablet computer, a server computer, a handheld computer, a handheld device, a PDA device, a handheld PDA device, an on-board device, an off-board device, a hybrid device, a mobile or portable device, a non-mobile or non-portable device, a wireless communication device, a cellular telephone, a Personal Communication Systems (PCS) device, a PDA device which incorporates a wireless communication device, a wired or wireless handheld device (e.g., BlackBeny, Palm Treo), a Wireless Application Protocol (WAP) device, or the like.

Player devices 102 may allow one or more users to participate in one or more online games 141 provided by at least one online gaming service 140. Gaming service 140 may include any suitable online service capable of providing at least one suitable indicia-based game 141 to players 102.

In some embodiments, the indicia-based game 141 may include a card game. For example, the card game may include a poker game, e.g., a Texas Hold'em poker game.

Some demonstrative embodiments are described herein in the context of a Texas Hold'em poker game. However, it should be appreciated that other embodiments may be implemented with reference to any other suitable game including any suitable indicia, for example, any other suitable poker game; any other suitable card game; any suitable game using any suitable indicia other than cards, e.g., tiles, dice, and the like.

In some embodiments, devices 102 may be implemented using suitable hardware components and/or software components, for example, processors, controllers, memory units, storage units, input units, output units, communication units, operating systems, applications, or the like.

In some embodiments, system 100 may include a side-game application 160 capable of providing to players 102 one or more side-game services and/or capabilities, for example, player-specific side-game services, e.g., as described in detail below.

In some embodiments, system 100 may also include an interface 110 to interface between players 102 and one or more elements of system 100, e.g., gaming service 140 and side-game application 160.

In some embodiments, side-game application 160 may be implemented as part of gaming service 140 and/or as part of any other suitable system or module, e.g., as part of any suitable server, or as a dedicated server.

In some embodiments, side-game application 160 may include a local or remote application executed by any suitable computing system 183. For example, computing system 183 may include a suitable memory 187 having stored thereon side-game application instructions 189; and a suitable processor 185 to execute instructions 189 resulting in side-game application 160. In some embodiments, computing system 183 may include a server to provide the functionality of side-game application 160 to users 102. In other embodiments, computing system 183 may be part of station 102. For example, instructions 189 may be downloaded and/or received by players 102 from another computing system, such that side-game application 160 may be executed locally by players 102. For example, instructions 189 may be received and stored, e.g., temporarily, in a memory or any suitable short-term memory or buffer of player device 102, e.g., prior to being executed by a processor of player device 102. In other embodiments, computing system 183 may include any other suitable computing arrangement and/or scheme.

In some embodiments, computing system 183 may also execute gaming service 140. In other embodiments, side-game application 160 may be implemented separately from gaming service 140.

In some embodiments, interface 110 may be implemented as part of side-game application 160, gaming service 140 and/or as part of any other suitable system or module, e.g., as part of any suitable server.

In some embodiments, interface 110 may be associated with and/or included as part of devices 102. In one example, interface 110 may be implemented, for example, as middleware, as part of any suitable application, and/or as part of a server. Interface 110 may be implemented using any suitable hardware components and/or software components, for example, processors, controllers, memory units, storage units, input units, output units, communication units, operating systems, applications. In some embodiments, interface 110 may include, or may be part of a Web-based gaming application, a web-site, a web-page, a stand-alone application, a plug-in, an ActiveX control, a rich content component (e.g., a Flash or Shockwave component), or the like.

In some embodiments, interface 110 may be configured to allow players 102 to interact with side-game application 160 and/or gaming service 140, for example, to play one or more online games offered by service 140, and/or to play one or more side-games associated with the online games, and/or to otherwise control the user's gaming operations with respect to the online games and/or side-games, e.g., as described below.

In some embodiments, interface 110 may include or be part of gaming service 140, side game application 160 and/or one or more other services.

In some embodiments, interface 110 may interface gaming service 140 and/or side-game application with one or more other modules and/or devices, for example, a gateway (GW) 194 and/or an application programming interface (API) 193, for example, to transfer information from side-game application 160 and/or gaming service 140 to one or more other, e.g., internal or external, parties, users, applications and/or systems.

In some embodiments, interface 110 may include at least one side-game interface tool 111 to provide a player using device 102 with one or more player-specific side-game scenarios, to receive from the player one or more wagers corresponding to the side-game scenarios, to provide the player with one or more messages corresponding to the side-game scenarios, and/or to perform any other suitable interface operations to interface between the player and side-game application 160, e.g., as described herein.

In some embodiments, interface 110 and/or interface 111 may include any suitable Graphic-User-Interface (GUI) and/or any other suitable interface.

In some embodiments, the online indicia-based game 141 provided by service 140 may include dealing one or more player indicia to each of one or more players, e.g., as described below.

In some embodiments, the online indicia-based game 141 provided by service 140 may include dealing a first number, equal to or greater than one, of player indicia to each of one or more players and dealing a second number, equal to or greater than one, of community indicia revealed to all of the players. In one example, the online game may include the Texas Hold'em poker game, in which two player cards are dealt to each player and five community cards are revealed to all the players, e.g., during three rounds.

In some embodiments, side-game application 160 may be capable of automatically offering to a player one or more player-specific side-games relating to online game 141 provided by gaming service 140, e.g., as described in detail below.

In some embodiments, side-game application 160 may be configured to receive player-indicia information representing player indicia already dealt to player 102 prior to the dealing of at least one un-dealt indicia. The at least one un-dealt indicia may include at least one of a player indicia to be dealt to player 102 and a community indicia to be revealed to all players of the online game. Side-game application 160 may receive the player-indicia information from gaming service 140, interface 110, player device 102 and/or any other suitable element of system 100.

In some embodiments, side-game application 160 may automatically determine, based at least one the player-indicia information, one or more player-specific side-game scenarios, each defining a winning criterion relating to the one or more un-dealt indicia; side-game application 160 may automatically offer to player 102 a side-game including the one or more player-specific side-game scenarios; side-game application 160 may receive at least one wager from player 102 corresponding to at least one respective wagered side-game scenario of the one or more scenarios; and, upon a dealing of the un-dealt indicia of the wagered scenario, side game application 160 may automatically reward player 102 if the criterion corresponding to the wagered scenario is met, e.g., a described herein.

In some embodiments, the criterion of a side-game scenario may define the identity of one or more of the un-dealt indicia, for example, a color, e.g., red or black; a type, e.g., spade, diamond, club or heart; and/or a value, e.g., ace, greater than five, lesser than nine, a “picture”, and the like. The side-game scenario may also define a reward ratio between a reward to be provided, if a wager is placed on the scenario and the un-dealt indicia meet the criterion, and the wager.

In some embodiments, side-game application 160 may automatically provide player 102 with a player-specific insurance scenario, which is based on the player-specific information, wherein the un-dealt indicia include one or more community indicia to be dealt after all the player indicia are dealt.

In some embodiments, the winning criterion of the insurance scenario may require that the un-dealt indicia, when dealt, will include indicia resulting in a first expected winning probability associated with a first combination of the player indicia and the community indicia after dealing the un-dealt indicia, wherein the first expected winning probability is lesser than a second expected winning probability associated with a second combination of the player indicia and community indicia prior to dealing the un-dealt indicia.

In some embodiments, side-game application 160 may allow player 102 participating in an online poker card game, e.g., as long as player 102 has not folded his hand, to place an “insurance” wager to hedge his current poker hand against bad bets, for example, by betting in favor of “unwanted” cards that could appear next in one or more un-dealt community cards to be dealt in during one or more future rounds. For example, side-game application 160 may provide player 102 with at least one insurance side-game scenario in the form of an “insurance side-bet line” enabling player 102 to hedge the current poker hand against bad bids, e.g., by betting in favor of unwanted cards that could appear next in the community cards.

In some embodiments, side-game application 160 may be is configured to automatically determine such “unwanted” cards, based at least on the player cards currently held by the participant (“the currently held cards”); and to offer to the participant a player-specific “insurance” side-bet, which is based at least on the currently held cards. For example, if the currently held cards include two “Kings”, then side-game application 160 may automatically determine that an “Ace” card, if dealt in the community cards, may poise a threat to the participant. Side-game application 160 may then allow player 102 to “hedge against” an “Ace” appearing on the flop, turn, and/or river cards, for example, by allowing the player to place a wager on the “Ace” appearing on the flop, turn, and/or river cards; and rewarding player 102, if the player places the wager and the “Ace” does appear on the flop, turn, and/or river cards.

In some embodiments, side-game application 160 may determine a wager to be offered to player 102 with respect to an insurance scenario in a customized way, for example, based on a current betted amount in the pot. For example, side-game application 160 may determine the wager corresponding to an insurance side-game scenario, such that a net sum rewarded to player 102, if the winning criterion of the scenario is met, will be approximately equal to the sum that player 102 may have been rewarded if player 102 has won the game. For example, side-game application 160 may determine the offered wager, such that a sum of the offered wager and the pot may be substantially equal to a product of the wager and the reward ratio of the scenario. For example, if the pot is 100$, and a reward ratio of an insurance scenario is 1:11, then application 160 may determine that the wager to be offered should be 10$. In other embodiments, side-game application may determine the wager to be offered with the insurance scenario according to any other suitable criterion.

In some embodiments, side-game application 160 may generate the insurance side-game scenarios to provide 102 in a manner, which may simulate operations performed by a professional poker player.

In a first example, player 102 may be dealt an ace of hearts and a king of hearts; and the flop community cards may include an ace of spades, a ten of hearts and a three of hearts. According to this example, player 102 holds a top pair. A revealing of an additional heart will have a threat of a flush. However, the revealing of the additional “heart” will result in player 102 having a flush as well, and accordingly will not actually “threaten” player 102. Therefore, side-game application 160 may be capable of automatically determining that an insurance side-game scenario relating to the revealing of a “heart” may not be offered to player 102.

In a second example, player 102 may be dealt an two of hearts and a ten of spades; and the turn community cards may include a six of hearts, a seven of spades, an eight of diamonds and a nine of clubs. According to this example, player 102 holds a straight (6, 7, 8, 9, 10). However, in a professional perspective, the revealing of a “10” card in the community cards will create a “straight” in the community cards. As a result, the player's hand will be neutralized, since all other players will also have at least the straight of player 102. Accordingly, side-game application 160 may automatically determine that the appearance of the card “10” at the river may pose a threat to player 102, and automatically offer player 102 with an insurance side-game scenario relating to the appearance of the card “10” in the community cards at the river.

In some embodiments, side-game application 160 may automatically provide player 102 with a post-withdrawal side-game scenario, e.g., upon player 102 withdrawing from the online game prior to dealing the un-dealt indicia, wherein the criterion of the post-withdrawal side-game scenario relates to the one or more un-dealt indicia, e.g., as described below.

In some embodiments, the un-dealt indicia may include one or more community indicia to be dealt after all player indicia have been dealt.

In some embodiments, the criterion of the post-withdrawal side-game scenario may require that, after dealing the one or more un-dealt indicia, the community indicia will form, together with the player indicia, a predefined winning indicia combination.

In some embodiments, side-game application 160 may be configured to allow player 102 of an online poker card game, which has withdrawn from a current game, e.g., if player 102 has “folded” his poker hand, to place a wager regarding one or more un-dealt cards to be dealt after player 102 has withdrawn. Accordingly, side-game application 160 may allow player to “play” his folded poker hand, by betting on one or more “wanted” cards, which player 102 had needed when he was still in the game, to be dealt in the community cards. For example, side-game application 160 may provide player 102 with at least one post-withdrawal side-game scenario in the form of an “after-fold” side bet line, to provide the participant with the chance to “play” the folded poker hand, e.g., by betting on cards player 102 would have needed prior to folding, to come next among the community cards.

In some embodiments, side-game application 160 may be configured to automatically determine the “wanted” cards of the post-withdrawal side-game scenario, based at least on the player cards of the folded hand, and to offer to player 102 a customized “after fold” side-bet, which is based at least on the player cards. For example, after player 102 had folded his hand, side-game application 160 may allow player 102 to bet on the chance that the next dealt community cards include one or more cards, which would have resulted in the folded hand, if played, receiving a predefined winning combination, e.g., a straight, a flush or even a straight flush.

In some embodiments, side-game application 160 may be configured to automatically determine the one or more side-game scenarios to be offered to player 102 based on, customized to and/or tailored to, the specific player cards dealt to player 102, e.g., such that different played hands, e.g., by different participants and/or by a common participant, will be allowed to perform different customized side-game scenarios corresponding to different card combinations and/or different betting and/or winning odds and/or payoffs, e.g., as described herein.

In some embodiments, side-game application 160 may automatically analyze the specific played hand of player 102; and, based at least on the specific player cards included in the played hand, side-game application 160 may offer to player 102 at least one player-specific “insurance” side bet, and/or at least one player specific “after fold” side bet.

In some embodiments, side-game application 160 may automatically provide player 102 with a player-specific general-community-indicia side-game scenario (“general side game scenario”), wherein the criterion of the general side-game scenario relates to the one or more un-dealt community indicia having one or more predefined winning combinations, and wherein a reward ratio of the general side-game scenario is based on the player-indicia information, e.g., as described below.

In some embodiments, side-game application 160 may be configured to provide user 102 with at least one general side-game in the form of a “general-line side-bet”, allowing player 102, e.g., while player 102 is still actively participating in the online game, to bet on the identity of one or more cards to appear in the community cards, while providing player 102 with customized betting odds, which are based on the player cards held by player 102.

In one embodiment, side-game application 160 may automatically provide player 102 with an option to bet in favor of one or more predefined combinations appearing in one or more of the un-dealt community cards, e.g., a “red” card, a “black” card, a “diamond”, a card greater than five, a “blackjack” combination, a combination having the value of “seven”, a combination having the value of “eleven”, a “pair”, and the like.

In some embodiments, side-game application 160 may be configured to automatically determine the reward ratio of the general-community-indicia side-game scenario based on the player cards currently held by player 102. For example, a first player holding two “red” cards, will be provided with a first reward ratio first for the appearance of a “red” card in the community cards; while a second player holding two “black” cards may be provided with second reward ratio odds, different from the first reward ratio, e.g., lesser than the first reward ration, for the appearance of a “red” card in the community cards.

In some embodiments, the online game 141 provided by gaming service 140 may include an indicia-based game including dealing one or more player indicia to each of one or more players, with or without dealing community indicia to all players. In one embodiment, the online game 141 provided by gaming service 140 may include dealing community indicia to all players, e.g., the online game 141 may include the Texas Hold'em poker game, in which five community cards are revealed to all players. However, in other embodiments, the online game 141 provided by gaming service 140 may include any other suitable online game, which includes dealing any other number of community indicia or even not dealing any community indicia.

In some embodiments, prior to a dealing of at least one un-dealt player indicia to player 102, side-game application 160 may be configured to automatically determine one or more player-indicia side-game scenarios, each defining a winning criterion relating to one or more of the un-dealt player indicia, and to automatically offer to player 102 a side-game including the one or more player-specific side-game scenarios.

In some embodiments, side-game application 160 may be configured to receive at least one wager from player 102 corresponding to at least one respective wagered side-game scenario of the one or more scenarios; and, upon a dealing of the un-dealt indicia of the wagered scenario, side-game application 160 may automatically reward player 102 if the criterion corresponding to the wagered scenario is met, e.g., as described below.

In some embodiments, side-game application 160 may be configured to offer the one or more player-indicia scenarios prior to dealing any player indicia to player 102. In other embodiments, side-game application 160 may be configured to offer the one or more player-indicia scenarios after dealing one or more player indicia to player 102, and prior to dealing one or more remaining player indicia to player 102.

In some embodiments, the winning criterions of the player-indicia side-game scenarios may include a predefined winning combination of one or more of the un-dealt player indicia, e.g., as described below.

In some embodiments, side-game application 160 may be configured to offer the one or more player-indicia side game scenarios to player 102 after player 102 has withdrawn from a currently played game, when player 102 is still active in the current game, or after the current game has ended. The one or more player-indicia side-game scenarios relate to un-dealt player indicia to be dealt to player 102 in a successive game.

In some embodiments, side-game application 160 may be configured to allow player 102 of a poker card game to bet on the cards to be dealt player 102 in a future game. In one embodiment, the side-game application 160 may provide player 102 with an option to bet in favor of one or more predefined combinations of the cards to be dealt to player 102 in a next game round, e.g., a “red” card, a “black” card, a “diamond”, a card greater than five, a “blackjack” combination, “black-jack” combination including an “ace” and a “ten” or a “picture”, a combination having the value of “seven”, a combination having the value of “eleven”, a “pair”, a pair of cards having the same color, and/or any other suitable combination.

In some embodiments, side-game application 160 may be configured to automatically provide player 102, when participating in a game (i.e. pre-flop, flop, turn or river) or after folding, with the option to wage the next two player (“pocket”) cards player 102 will receive in a next poker game. For example, the wager may be for player 102 receiving a pair, two cards of the same shape, two cards of the same color, at least one red card, at least one card greater than five, and the like.

In some embodiments, side-game application 160 may utilize a scenario definer 161 to automatically define the one or more player-specific side-game scenarios based on the player-specific information.

In some embodiments, scenario definer 161 may be configured to automatically determine the one or more specific “unwanted” cards, which may “threaten” the specific played hand of player 102, e.g., if player 102 has not fold his hand; and/or to determine the one or more specific “wanted” cards, which correspond the specific folded hand, e.g., if player 102 has folded his hand, e.g., as described below.

In some embodiments, side-game application 160 may utilize a reward-ratio definer 163 to automatically determine, based on the player-specific information, one or more player-specific reward ratios corresponding to the one or more side-game scenarios, respectively, each reward ratio defining a ratio between the reward and a player wager corresponding to the scenario, e.g., as described below.

In some embodiments, reward-ratio definer 163 may determine the reward ratio corresponding to a side-game scenario based on an expected probability of the un-dealt indicia meeting the criterion of the scenario, for example, an expected conditional probability of the un-dealt indicia meeting the criterion of the scenario taking into account the already dealt player cards and community cards, e.g., as described below.

In some embodiments, reward-ratio definer 163 may be implemented, for example, in the form of a suitable mathematical engine configured to determine, in a player-indicia-customized manner, the betting odds and/or the winning odds to be offered to the player with relation to the offered side bets. Accordingly, different participants and/or different played hands, which may be played during the same game round and/or base game, may be offered with different, customized, side bets and/or different, customized, betting and/or winning odds.

In some embodiments, side-game application 160 may be configured to automatically provide to player 102, e.g., via interface 110, the one or more reward ratios to player 102 in association with the one or more scenarios, respectively.

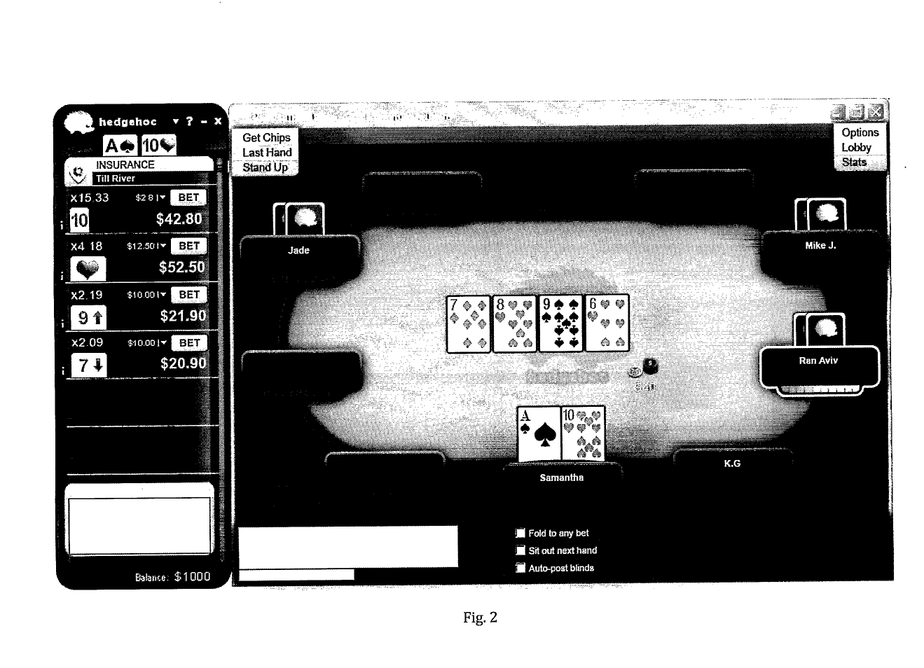

FIGS. 2-5 are schematic block diagram illustrations of interface components offering side-game scenarios, in accordance with a demonstrative embodiment. In some embodiments, the interface of FIGS. 2-5 may be implemented by interface 110 (FIG. 1) to offer to a player, e.g., player 102 (FIG. 1), one or more side-game scenarios generated by side-game application 160 (FIG. 1).

As shown in FIG. 2, a plurality of players, e.g., five players denoted “Mike J.”, “Ran Aviv”, “K. G.”, “Samantha” and “Jade”, respectively, may play an online Texas Hold'em poker game. As shown in FIG. 2, the player “Samantha” may be provided with a GUI including an online game interface associated with a side-game interface.

Some or all of the players may be actively participating in a certain game (“the current game”). For example, as shown in FIG. 2, only the four players “Mike J.”, “Ran Aviv”, “Samantha” and “Jade” may be actively participating in the current game, e.g., while “K. G.” may not be participating in the current game.

As shown in FIG. 2, each player may be dealt with two player cards, which may not be revealed to the other players. For example, the GUI may provide the player “Samantha” with only the two player-cards including an ace of spades and a ten of hearts, dealt to the player “Samantha”. Five community cards may be revealed to all players. The community cards may be revealed during rounds according to the Texas Hold'em poker game rules.

As shown in FIG. 2, the side-game interface may include a side-game scenario portion to provide the player “Samantha” with one or more player specific side-game scenarios.

As shown in FIG. 2, the side-game interface may include one or more additional portions, for example, a wager portion including information regarding one or more wagers placed by the player “Samantha”.

As shown in FIG. 2, side game application 160 (FIG. 1) may provide to Samantha at the “turn” round four side-game scenarios including two insurance scenarios in the form of two respective “side-bet insurance lines” and two general scenarios in the for, of two respective “general side-bet lines”. For example, the four side-bet scenarios may relate to community cards dealt until the “river” round. As shown in FIG. 2, a first insurance scenario may have a winning criterion requiring that a “ten” is dealt in the community cards until the river round, e.g., insuring Samantha against a potential “straight”; a second insurance scenario may have a winning criterion requiring that a “heart” is dealt in the community cards until the river round, e.g., insuring Samantha against a potential “Flush”; a first general scenario may have a winning criterion requiring that at least a “nine” is dealt in the community cards until the river round; and a second general scenario may have a winning criterion requiring that a “seven” or less is dealt in the community cards until the river round.

The first, second, third and fourth insurance scenarios may have reward ratios of 15.33, 4.18, 2.19, and 2.09, respectively.

In some embodiments, side-game application 160 (FIG. 1) may determine a wager to be offered to “Samantha” with respect to each insurance scenario in a customized way, for example, based on the current betted amount in the pot. For example, as shown in FIG. 2, the pot may be 40$, and accordingly side-game application 160 (FIG. 1) may automatically determine the wager corresponding to the first insurance scenario to be 2.80$, e.g., since 2.80*15.33 is approximately equal to 40+2.8; and the wager corresponding to the second insurance scenario to be 12.50$, e.g., since 12.50*4.18 is approximately equal to 40+12.50. The first and second general scenarios may offer “Samantha” to place wagers of 10$ and 10$, respectively.

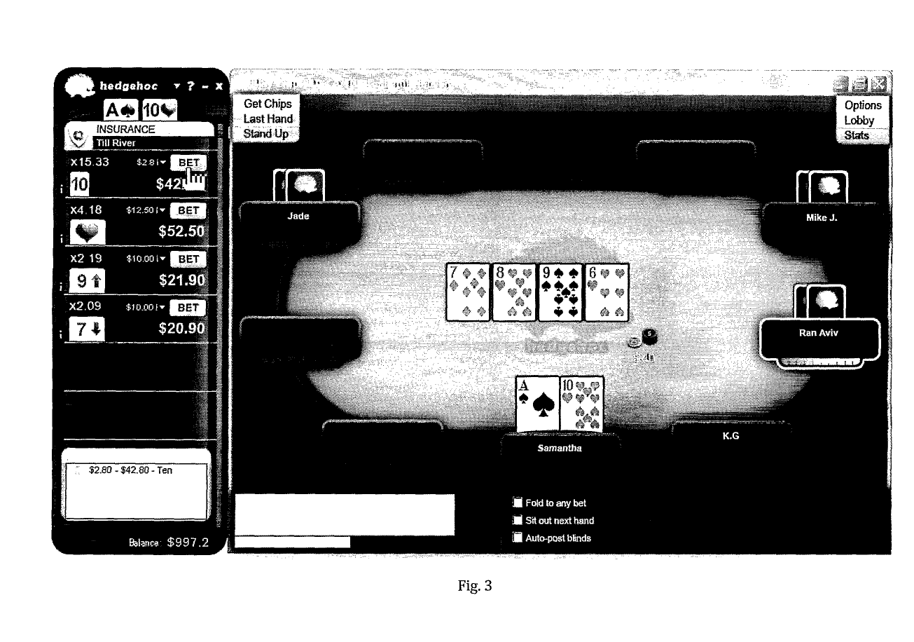

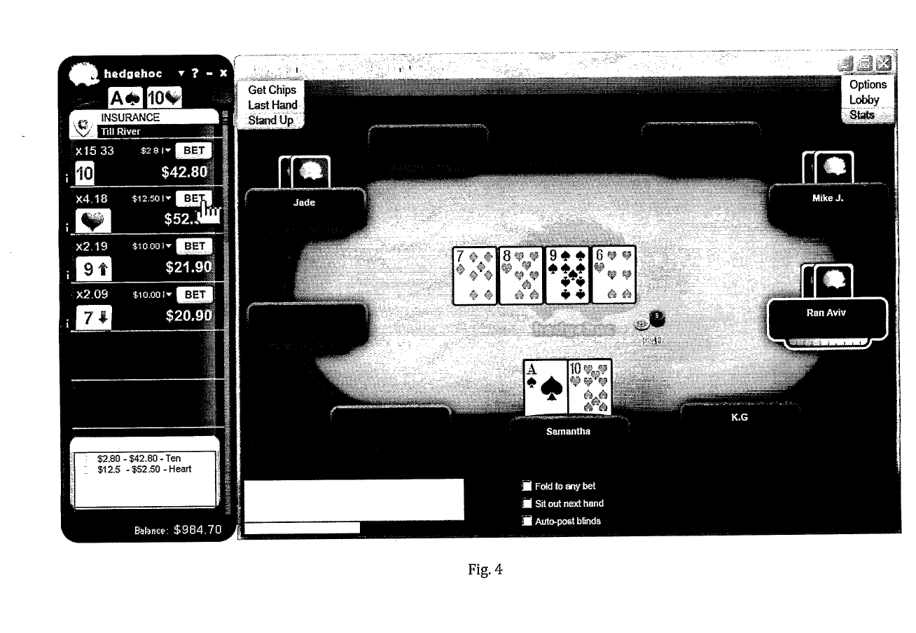

As shown in FIG. 3, Samantha may select to place a wager of 2.80$ on the first insurance scenario. As shown in FIG. 4, Samantha may select to place a wager of 12.50$ on the second insurance scenario.

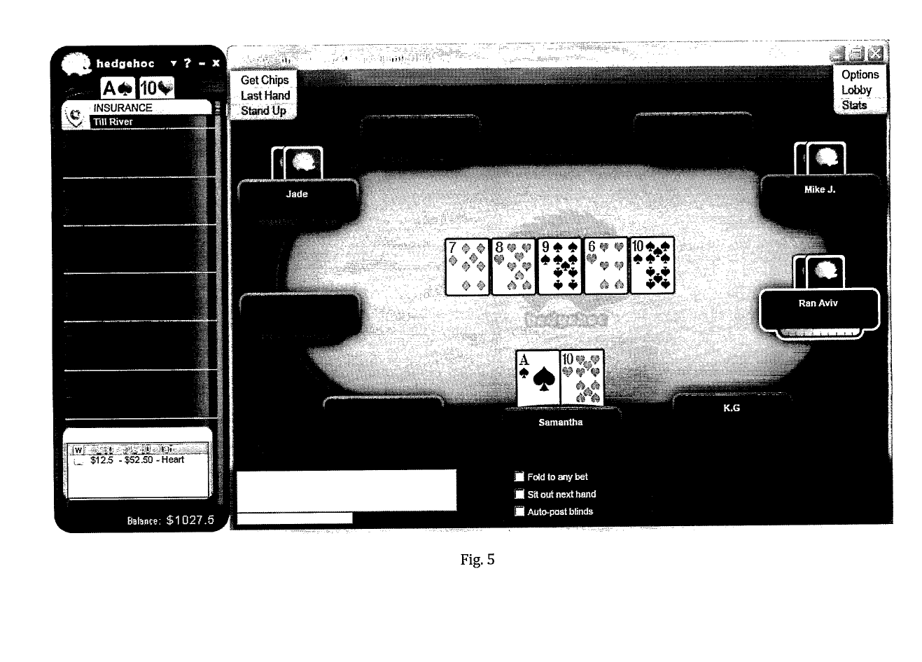

As shown in FIG. 5, upon dealing a community card in the form of the ten of spades, application 160 (FIG. 1) may automatically reward Samantha with 42.80$, according to the reward ratio of the first insurance scenario, since the winning criterion of the first insurance scenario has been met.

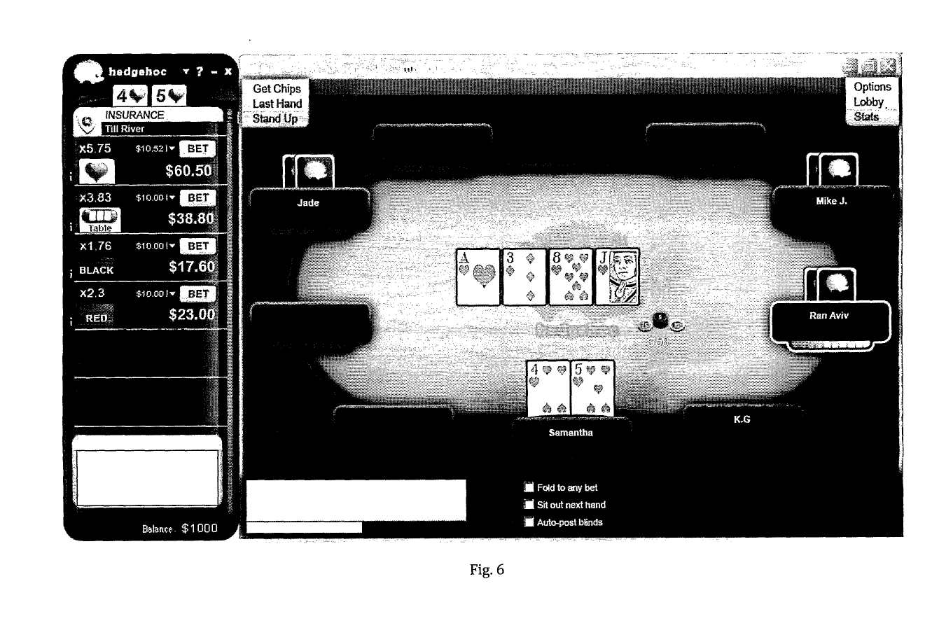

FIGS. 6-8 are schematic block diagram illustrations of interface components offering side game scenarios, in accordance with another demonstrative embodiment. In some embodiments the interface of FIGS. 6-8 may be implemented by interface 110 (FIG. 1) to offer to a player, e.g., player 102 (FIG. 1), one or more side-game scenarios generated by side-game application 160 (FIG. 1).

As shown in FIG. 6, side game application 160 (FIG. 1) may provide Samantha at the “turn” round with two side-game insurance scenarios in the form of two respective “side-bet insurance lines”. For example, the two side-bet insurance scenarios may relate to community cards dealt until the “river” round. As shown in FIG. 6, a first insurance scenario may have a winning criterion requiring that a “heart” is dealt in the community cards until the river round, e.g., insuring Samantha against a potential “flush”; a second insurance scenario may have a winning criterion requiring that a card of the same value of any one of the current community cards, e.g., an ace, three, eight and/or jack, is dealt until the river round, e.g., insuring Samantha a gains a potential “pair”. Side-game application 160 (FIG. 1) may also provide Samantha with two general side-game scenarios, for example, a first general scenario having a winning criterion requiring that any “black” card, e.g., a spade or a club, is dealt in the community cards until the river round; and a second insurance scenario having a winning criterion requiring that any “red” card, e.g., a diamond or a heart, is dealt in the community cards until the river round. The first, second, third and fourth side game scenarios may offer Samantha to place wagers of 10.52$, 10$, 10$ and 10$, respectively. The first, second, third and fourth insurance scenarios may have reward ratios of 5.75, 3.83, 1.76 and 2.3, respectively.

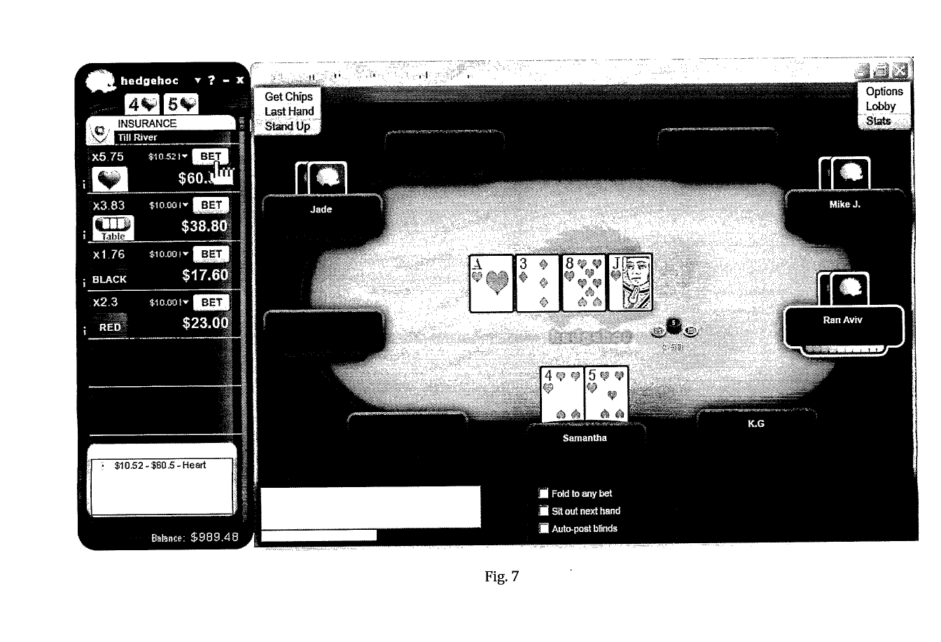

As shown in FIG. 7, Samantha may select to place a wager of 10.52$ on the first side-game scenario.

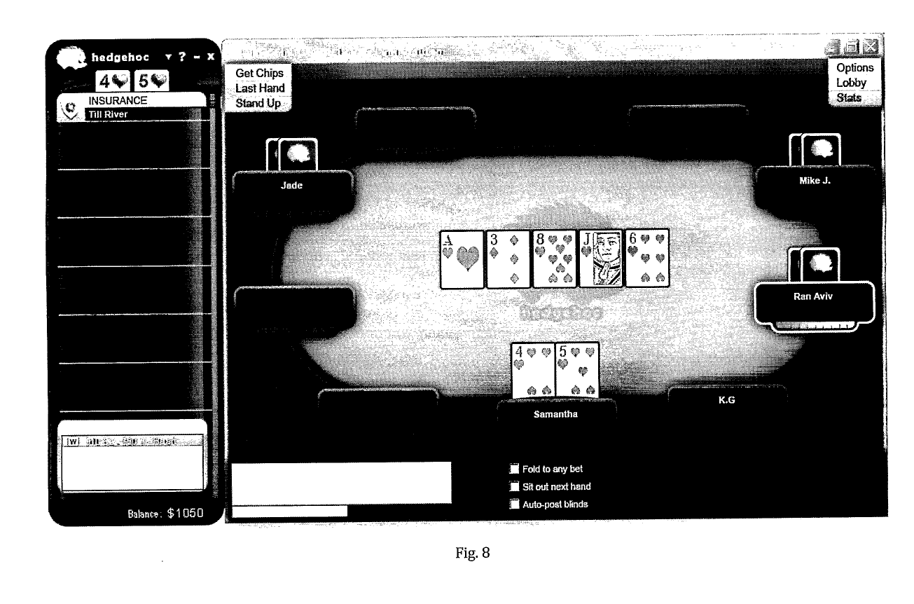

As shown in FIG. 8, upon dealing a community card in the form of the six of hearts, application 160 (FIG. 1) may automatically reward Samantha with 60.5$, according to the reward ratio of the first side game scenario, since the winning criterion of the first side-game scenario has been met.

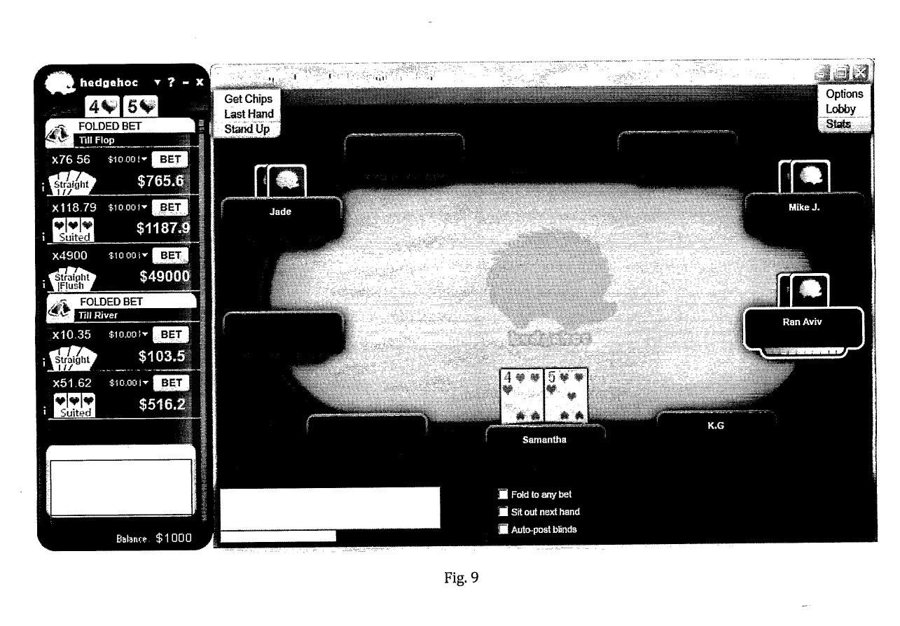

FIGS. 9-14 are schematic block diagram illustrations of interface components offering side game scenarios, in accordance with another demonstrative embodiment. In some embodiments the interface of FIGS. 9-14 may be implemented by interface 110 (FIG. 1) to offer to a player, e.g., player 102 (FIG. 1), one or more side-game scenarios generated by side-game application 160 (FIG. 1).

As shown in FIG. 9, Samantha may have selected to “fold” at the “pre-flop” round, while having the player cards four of hearts, and five of hearts. Side game application 160 (FIG. 1) may automatically provide Samantha at the “pre-flop” round with five side-game post-withdrawal scenarios in the form of five respective “after-fold side-bet lines”. For example, the five after-fold lines may include three after-fold lines relating to community cards dealt until the “flop” round, and two after-fold lines relating to community cards dealt until the “river” round. As shown in FIG. 9, a first after-fold scenario may have a winning criterion requiring that a combination of the player cards and community cards dealt until the flop form a “straight”; a second after-fold scenario may have a winning criterion requiring that a combination of the player cards and community cards dealt until the flop form a “flush” of hearts; a third after-fold scenario may have a winning criterion requiring that a combination of the player cards and community cards dealt until the flop form a “straight flush”; a fourth after-fold scenario may have a winning criterion requiring that a combination of the player cards and community cards dealt until the river form a “straight”; and a fifth after-fold scenario may have a winning criterion requiring that a combination of the player cards and community cards dealt until the river form a “flush” of hearts. The first, second, third, fourth and fifth side game scenarios may offer Samantha to place wagers of 10$, 10$, 10$, 10$ and 10$, respectively. The value of the offered wager may depend, for example, on a base/minimal betting amount of the game. The first, second, third, fourth and fifth side-game scenarios may have reward ratios of 76.56, 118.79, 4900, 10.35 and 51.62, respectively.

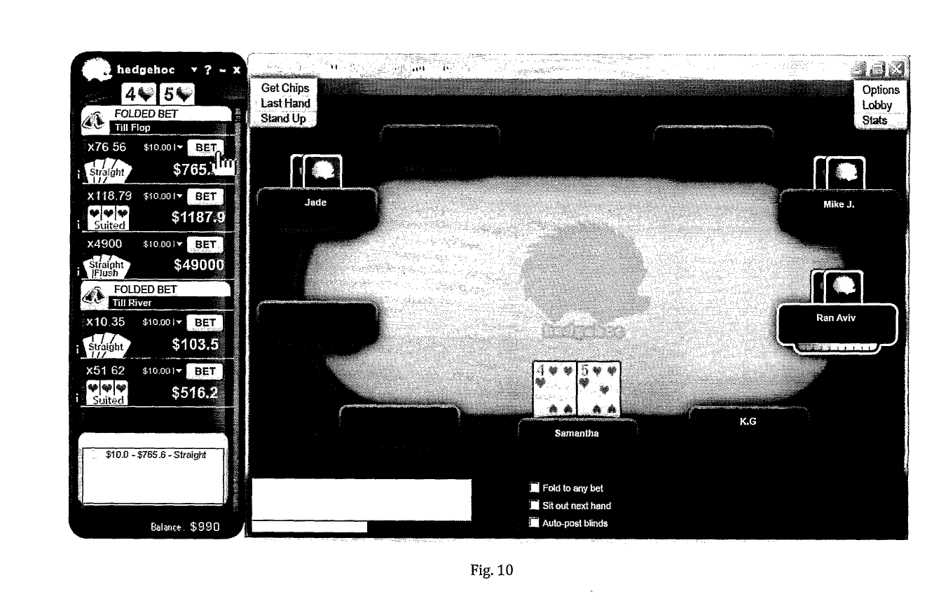

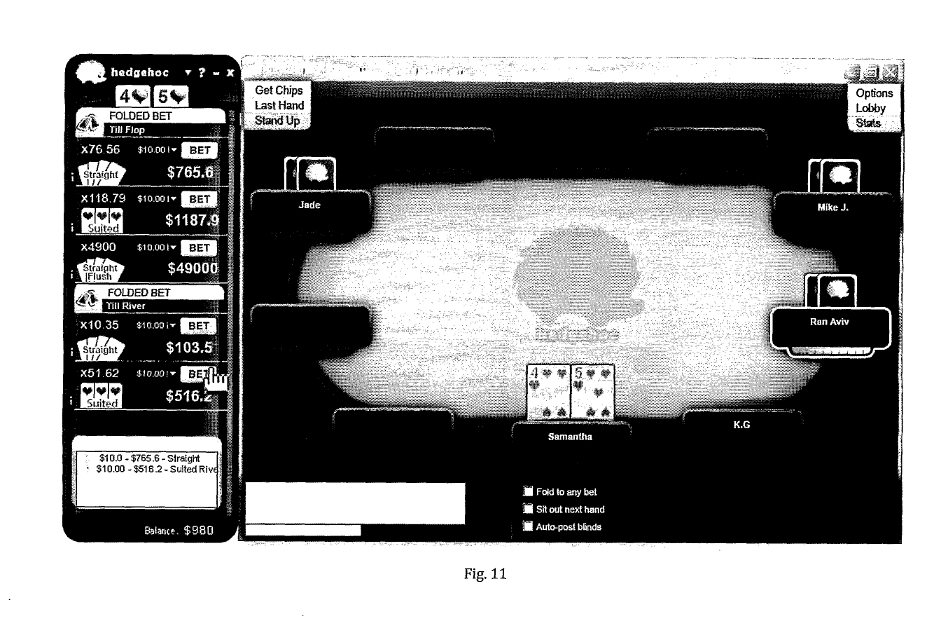

As shown in FIG. 10, Samantha may select to place a wager of 10$ on the first side-game scenario. As shown in FIG. 11, Samantha may select to place a wager of 10$ on the fifth side-game scenario.

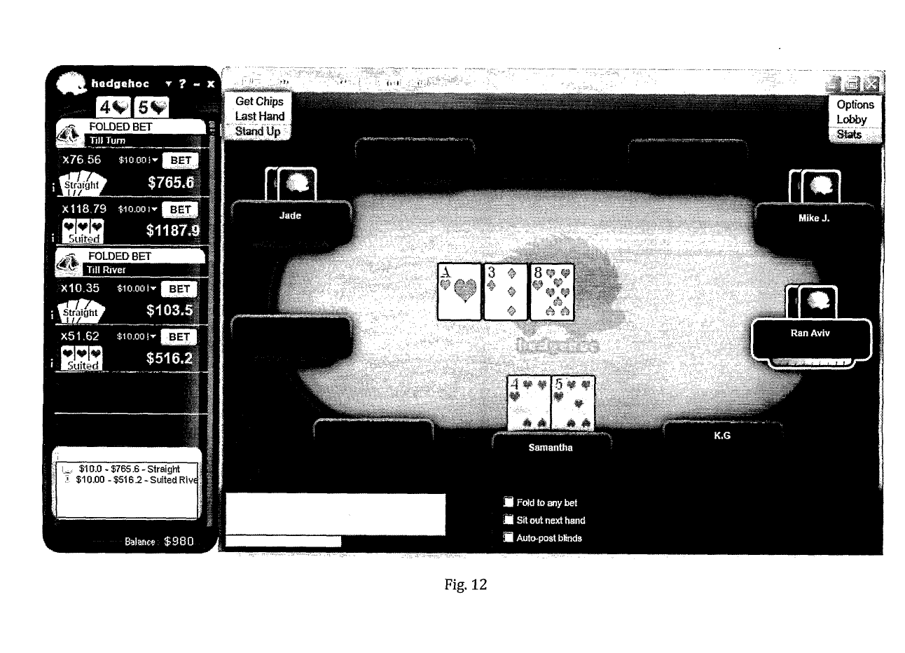

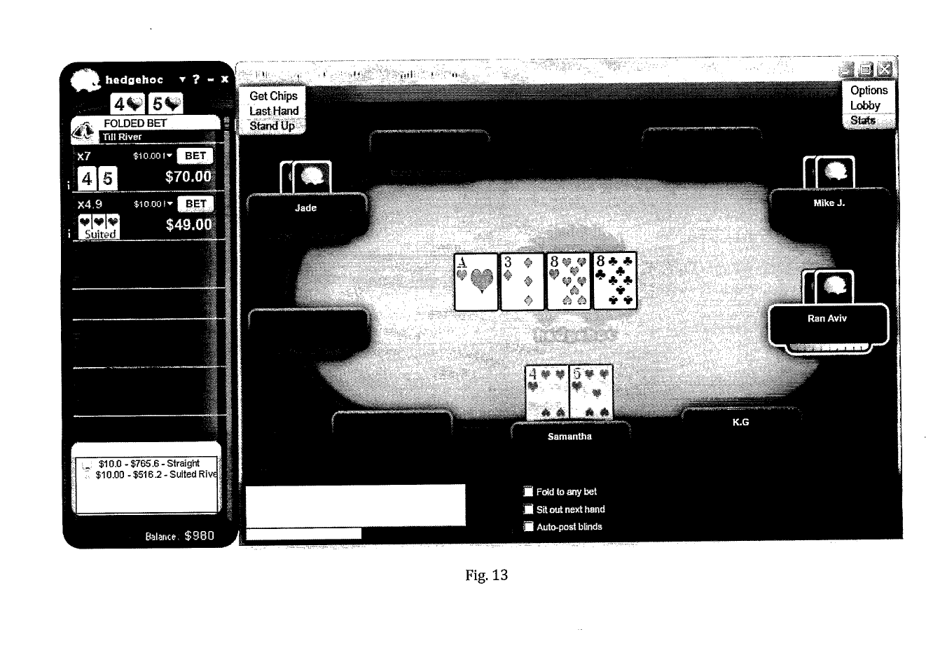

As shown in FIG. 12, the three community cards dealt in the flop may not meet the winning criteria of neither one of the first and fifth wagered side-game scenarios. As shown in FIG. 13, the fourth community card dealt in the turn may not meet the winning criteria of neither one of the first and fifth wagered side-game scenarios.

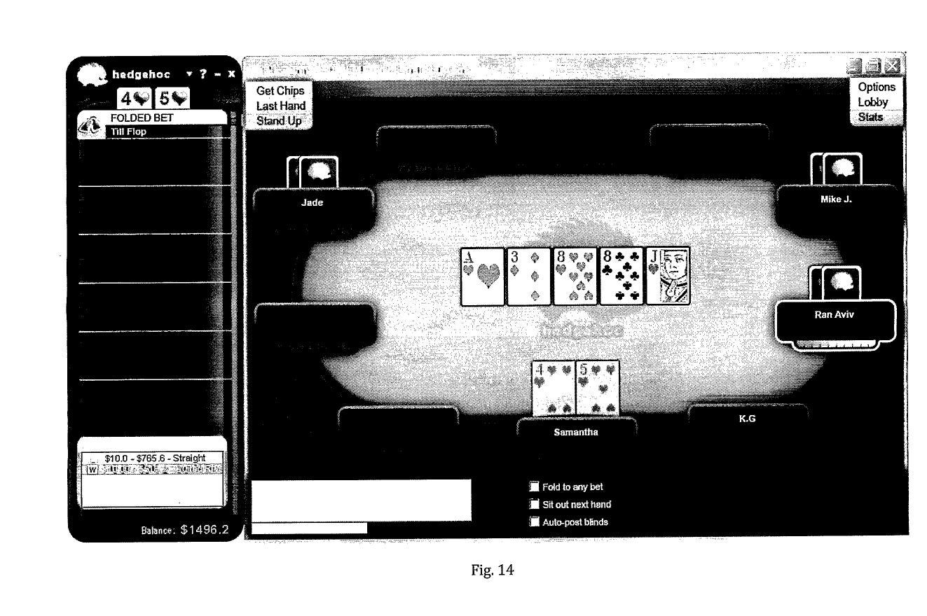

As shown in FIG. 14, upon dealing the fifth community card in the form of the jack of hearts, application 160 (FIG. 1) may automatically reward Samantha with 516.2$, according to the reward ratio of the fifth side game scenario, since the winning criterion of the fifth side-game scenario has been met.

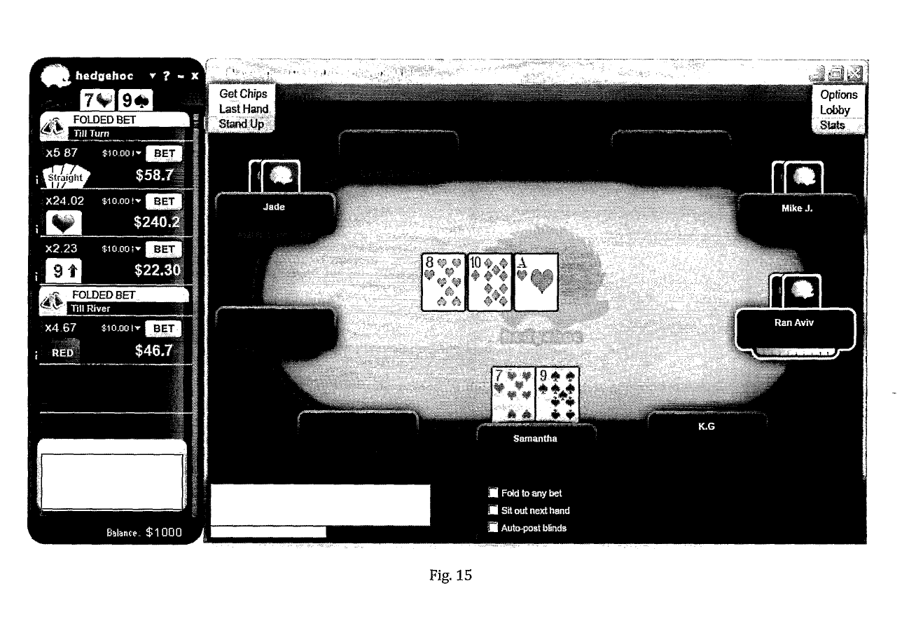

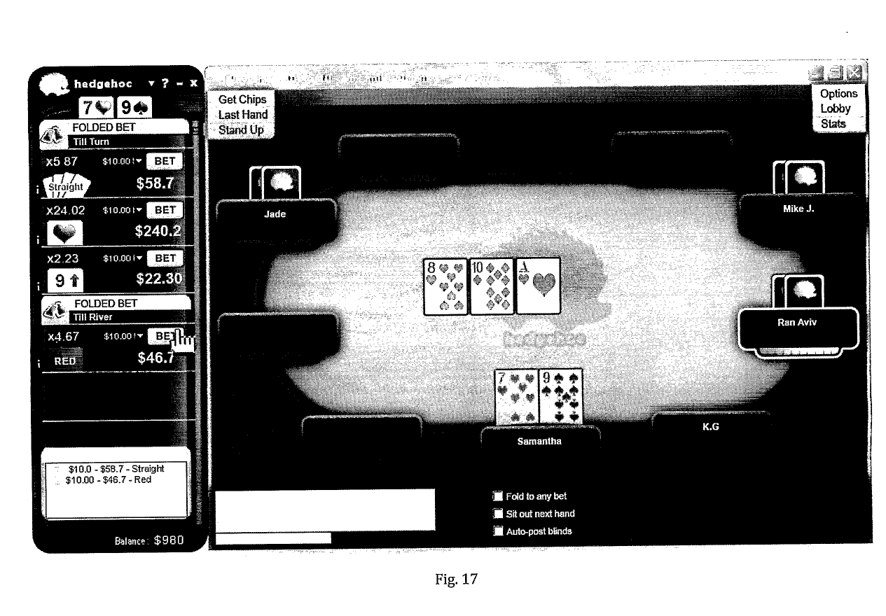

FIGS. 15-19 are schematic block diagram illustrations of interface components offering side game scenarios, in accordance with yet another demonstrative embodiment. In some embodiments the interface of FIGS. 15-19 may be implemented by interface 110 (FIG. 1) to offer to a player, e.g., player 102 (FIG. 1), one or more side-game scenarios generated by side-game application 160 (FIG. 1).

As shown in FIG. 15, Samantha may have selected to “fold” at the “flop” round, while having the player cards seven of hearts, and nine of spades, and the community cards eight of hearts, ten of diamonds, and ace of hearts. Side game application 160 (FIG. 1) may automatically provide Samantha at the “flop” round with four side-game scenarios in the form of four respective “side-bet lines”. For example, side-bet lines may include an after-fold line may relating to a fourth community card dealt at the “turn” round, two general side-bet lines relating to the fourth community card dealt in the “turn” round, and general line relating to community cards dealt until the “river” round. As shown in FIG. 9, a first after-fold scenario may have a winning criterion requiring that a combination of the player cards and community cards dealt until the turn form a “straight”; a first general scenario may have a winning criterion requiring that the fourth community card is a heart; a second general scenario may have a winning criterion requiring that the fourth community card is a nine or higher; and a third general scenario may have a winning criterion requiring that at least one of the fourth and fifth community cards are red. The first, second, third and fourth side-game scenarios may offer Samantha to place wagers of 10$, 10$, 10$, 10$ and 10$, respectively. The first, second, third and fourth side-game scenarios may have reward ratios of 5.87, 24.02, 2.23 and 4.67, respectively.

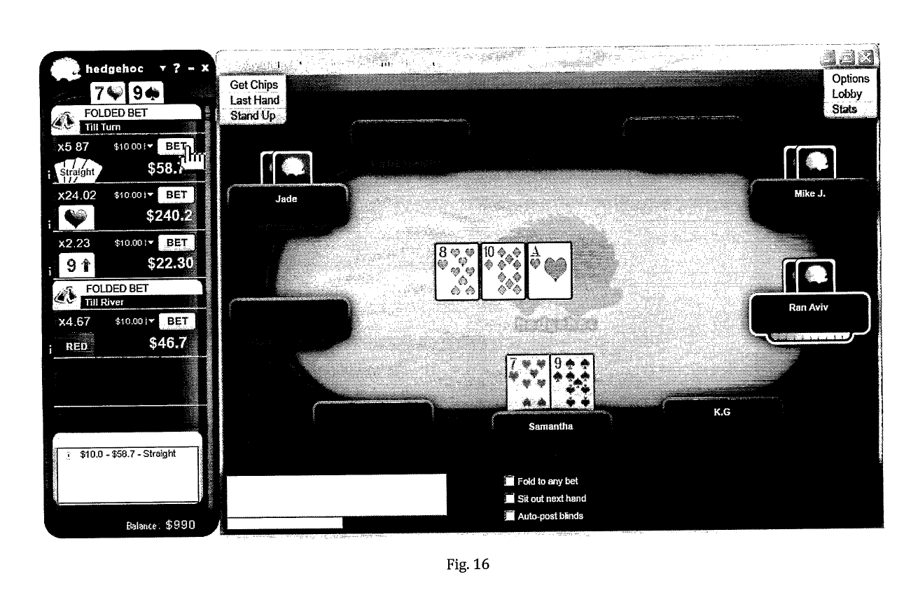

As shown in FIG. 16, Samantha may select to place a wager of 10$ on the first side-game scenario. As shown in FIG. 11, Samantha may select to place a wager of 10$ on the fourth side-game scenario.

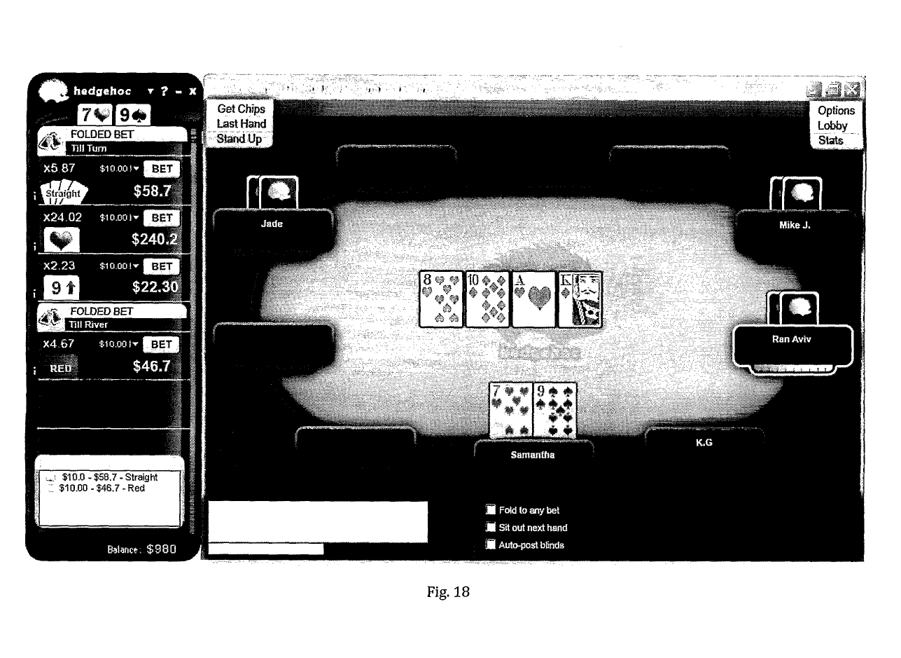

As shown in FIG. 18, the fourth community card dealt at the turn may not meet the winning criteria of neither one of the first and fourth wagered side-game scenarios.

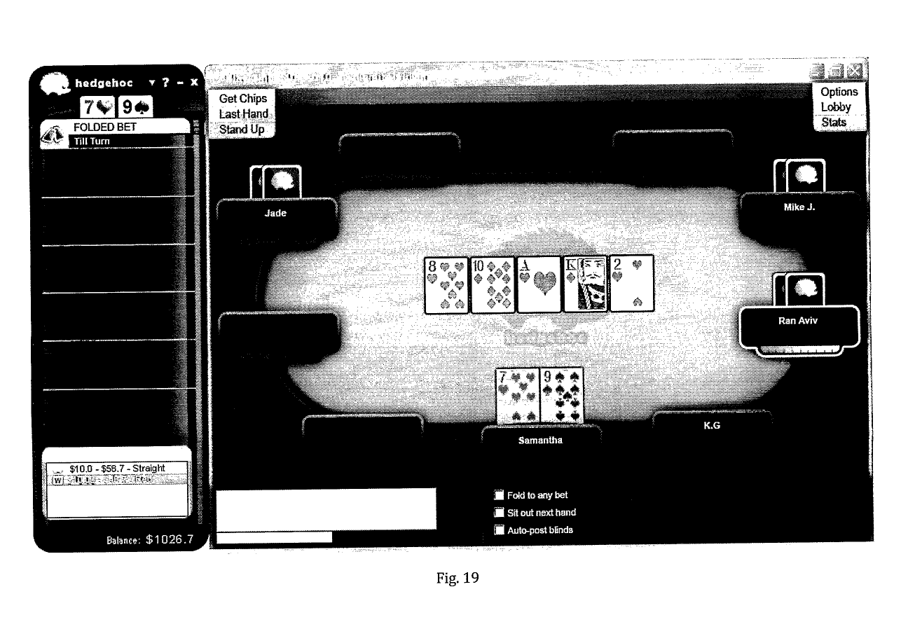

As shown in FIG. 19, upon dealing the fifth community card in the form of the two of hearts, application 160 (FIG. 1) may automatically reward Samantha with 46.7$, according to the reward ratio of the fourth side game scenario, since the winning criterion of the fourth side-game scenario has been met.

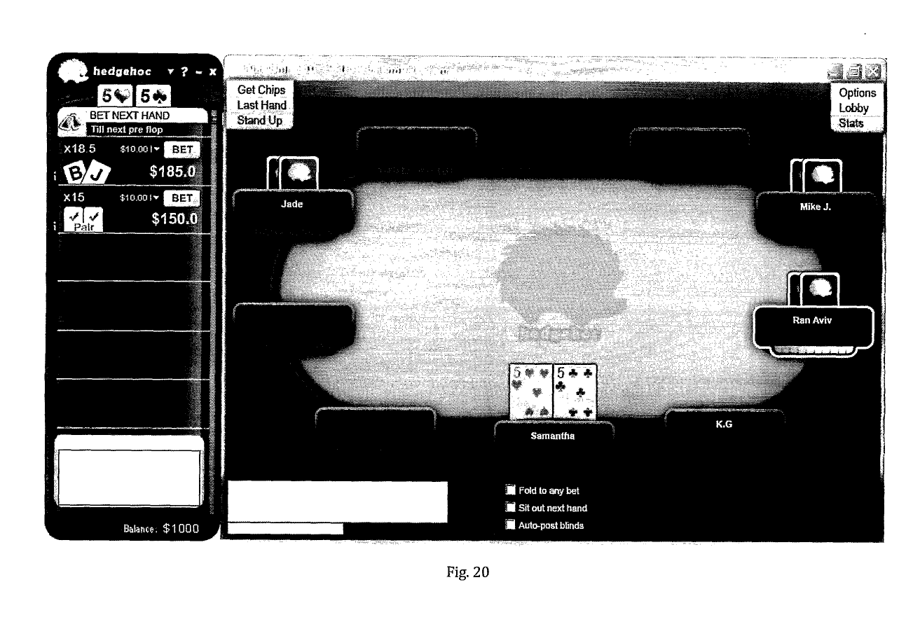

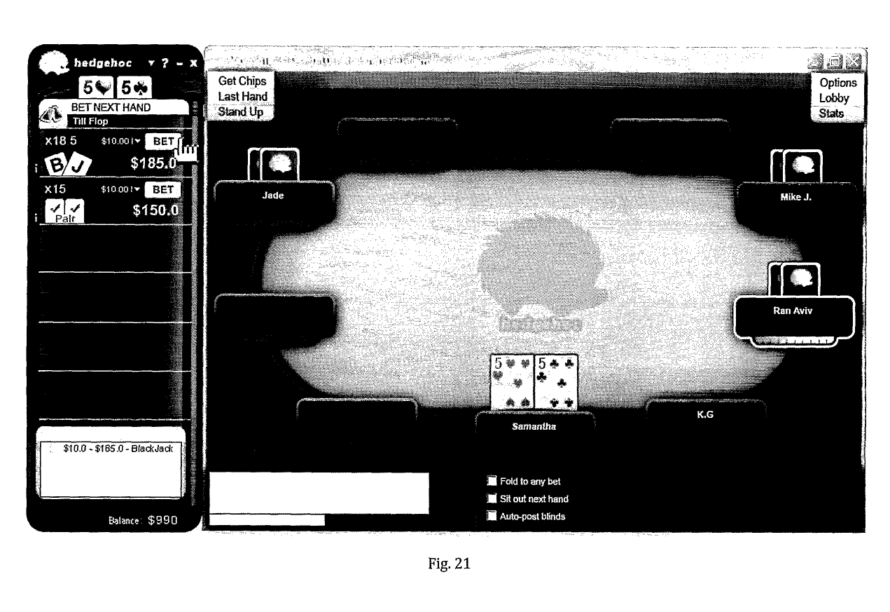

FIGS. 20-21 are schematic block diagram illustrations of interface components offering side game scenarios, in accordance with yet another demonstrative embodiment. In some embodiments the interface of FIGS. 20-22 may be implemented by interface 110 (FIG. 1) to offer to a player, e.g., player 102 (FIG. 1), one or more side-game scenarios generated by side-game application 160 (FIG. 1).

As shown in FIG. 20, application 160 (FIG. 1) may automatically offer two player-card side-game scenarios to Samantha, which may have selected to “fold” at the “flop” round. For example, the two player-card scenarios may include two bet-the-pocket lines relating to two player cards to be dealt to Samantha in a succeeding game. As shown in FIG. 20, a first player-card scenario may have a winning criterion requiring that a the two player cards dealt to Samantha in the next game form a “black-jack” combination; and a second player-card scenario may have a winning criterion requiring that the two player cards form a “pair” combination. The first and second side-game scenarios may offer Samantha to place wagers of 10 and 10$, respectively. The first and second side-game scenarios may have reward ratios of 18.5 and 15, respectively.

As shown in FIG. 21, Samantha may select to place a wager of 10$ on the first side-game scenario. As shown in FIG. 11, Samantha may select to place a wager of 10$ on the fourth side-game scenario. If the player cards dealt to Samantha at the next game meet the winning criteria of the wagered first scenario, application 160 (FIG. 1) may automatically reward Samantha with 185$, according to the reward ratio of the first side game scenario.

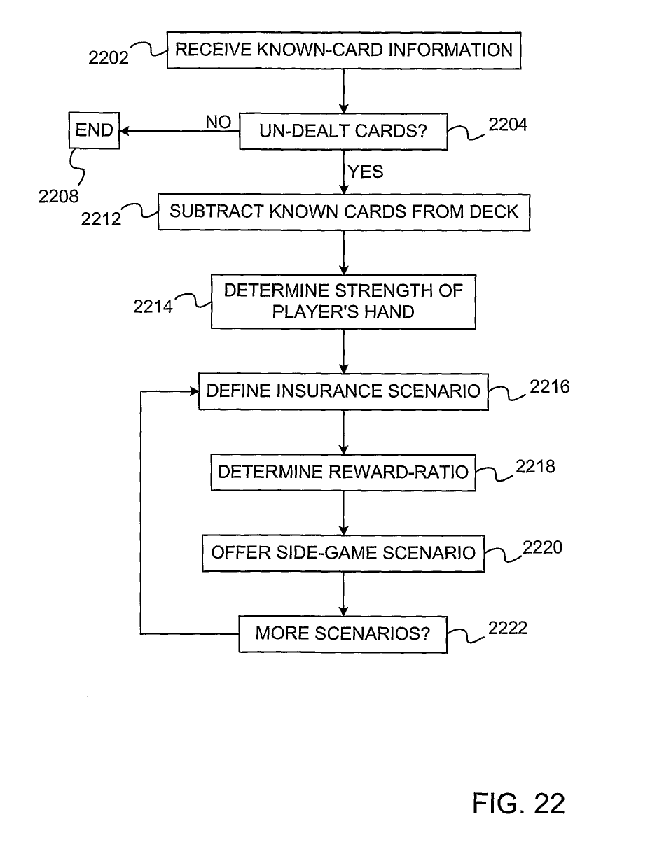

Reference is made to FIG. 22, which schematically illustrates a method of determining one or more insurance side-game scenarios, in accordance with some demonstrative embodiments. In some embodiments, one or more operations of the method of FIG. 22 may be implemented by side-game application 160 (FIG. 1) for example, to determine and offer one or more insurance side-game scenarios to player 102 (FIG. 1) of an online Texas Hold'em poker game provided by service 140 (FIG. 1).

As indicated at block 2202, the method may include receiving known-card information representing player cards and any already-dealt community cards. For example, the known-card information may include two player cards, if the known-card information is received at the pre-flop round; the two player cards and three community cards, if the known-card information is received at the flop round; or the two player cards and four community cards, if the known-card information is received at the turn round.

As indicated at block 2204, the method may include determining whether or not there are any un-dealt cards to be dealt, e.g., by determining whether or not the number of known cards is equal to or less than seven.

As indicated at block 2208, the method may include completing without returning any scenario, if there are no un-dealt cards to be dealt, e.g., if all seven cards have been dealt.

As indicated at block 2212, the method may include subtracting the known cards from a full deck of cards to determine a set of potential cards to be dealt (“the unknown cards”). For example, at the pre-flop round the set of potential cards may include fifty cards remaining after subtracting the two player cards from a full deck of 52 cards; at the flop round the set of potential cards may include forty seven cards remaining after subtracting the two player cards and the three community cards from the full deck of 52 cards; and at the turn round the set of potential cards may include forty six cards remaining after subtracting the two player cards and the four community cards from the full deck of 52 cards.

As indicated at block 2214, the method may include determining a “strength” of the player's hand based on the known and unknown cards. At the pre-flop round, for example, the strength of the hand can be a pair or not. At the flop and turn rounds, the strength of the hand may relate to a combination of the to player cards and the known community cards.

As indicated at bock 2216, the method may include defining one or more insurance scenarios to cover potential threats in the form of potential stronger hands, which may be potentially provided to one or more opponent players. It is noted, that there will not always be stronger hands, for example, in the case that the player's hand forms, together with the community cards, a straight flush (the strongest hand in poker).

In one example, at the flop round the player cards may include a seven of hearts and an eight of hearts, while the community cards may include a seven of spades, an eight of diamonds, and a nine of spades. According to this example, scenario definer 161 (FIG. 1) may determine that the player has two pairs (two sevens and two eights), and identifying one or more potential threatening scenarios. For example, since the player holds two pairs, the potential threatening scenarios may include at least a straight and/or a flush, as well as other potential threats.

Upon determining the strength of the player's hand and identifying the potential threatening scenarios, defining the one or more insurance scenarios may include determining whether or not the opponents may hold potential hands of the threatening scenarios.

In one example, at the flop round the player's cards may include a pair of kings, and the community cards may include a three of hearts, a four of spades, and a ten of hearts. According to this example, scenario definer 161 (FIG. 1) may determine that the player holds a “top pair”, which is the strongest available hand at this round. Scenario definer 161 (FIG. 1) may identify one or more, e.g., all, potential threatening scenarios. For example, scenario definer 161 (FIG. 1) may define the following insurance scenarios, e.g., based on the community cards:

A. Appearance of another heart-shaped card, which may result in a threat of a flush, e.g., if an opponent player has two heart-shaped cards; and/or

B. Appearance of the cards two and/or five, which will in a threat of a straight.

As indicated at block 2218, the method may include determining one or more reward-ratios corresponding to the one or more insurance scenarios. For example, scenario definer 161 (FIG. 1) may provide reward-ratio definer 163 (FIG. 1) with information regarding the known cards, and the potential cards, which may result in the threatening scenarios. For example, the potential cards may include any “heart” card relating to the first insurance scenario described above, and the cards “two” or “five”, relating to the second insurance scenario describes above.

As indicated at block 2220, the method may include offering to the player the one or more insurance scenarios. For example, side-game application 160 (FIG. 1) may provide player 102 (FIG. 1), e.g., via interface 110 (FIG. 1) with two side bet insurance lines, including a first line to insure against the appearance of an additional heart-shaped card, and a second line to insure against the appearance of a two and/or a five. In this example, player 102 (FIG. 1) may be provided with two insurance lines, however it will be appreciated that any other number of insurance lines may be offered to player 102 (FIG. 1).

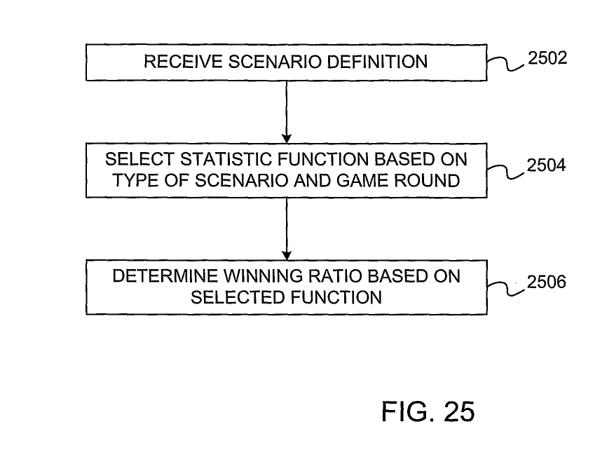

In some embodiments, the player may be provided with an option to choose a round in the game until which the player wants to have the insurance, and the calculation of the reward-ratio and/or a price of the wager to be placed on the insurance line may be determined by reward-ratio definer 163 (FIG. 1) according to the selected round, e.g., as described below with reference to FIG. 25.

As indicated at block 2222, the method may include repeating the operations of blocks 22216, 2218 and 2220 for one or more additional insurance scenarios.

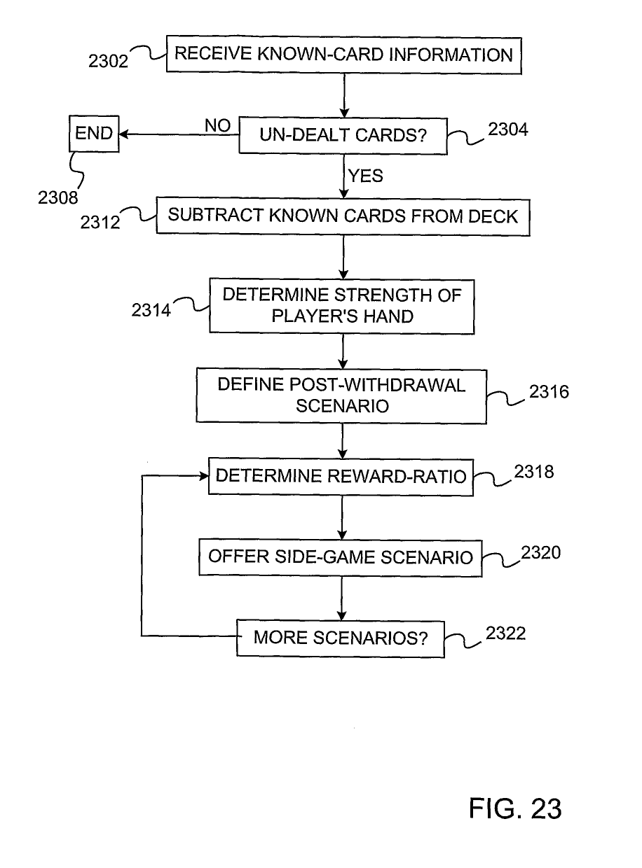

Reference is made to FIG. 23, which schematically illustrates a method of determining one or more post-withdrawal side-game scenarios, in accordance with some demonstrative embodiments. In some embodiments, one or more operations of the method of FIG. 23

As indicated at block 2302, the method may include receiving known-card information representing player cards and any already-dealt community cards. For example, the known-card information may include two player cards, if the known-card information is received at the pre-flop round; the two player cards and three community cards, if the known-card information is received at the flop round; or the two player cards and four community cards, if the known-card information is received at the turn round.

As indicated at block 2304, the method may include determining whether or not there are any un-dealt cards to be dealt, e.g., by determining whether or not the number of known cards is equal to or less than seven.

As indicated at block 2308, the method may include completing without returning any scenario, if there are no un-dealt cards to be dealt, e.g., if all seven cards have been dealt.

As indicated at block 2312, the method may include subtracting the known cards from a full deck of cards to determine the unknown cards. For example, at the pre-flop round the set of potential cards may include fifty cards remaining after subtracting the two player cards from a full deck of 52 cards; at the flop round the set of potential cards may include forty seven cards remaining after subtracting the two player cards and the three community cards from the full deck of 52 cards; and at the turn round the set of potential cards may include forty six cards remaining after subtracting the two player cards and the four community cards from the full deck of 52 cards.

As indicated at block 2314, the method may include determining the strength of the player's hand based on the known and unknown cards. At the pre-flop round, for example, the strength of the hand can be a pair or not. At the flop and turn rounds, the strength of the hand may relate to a combination of the to player cards and the known community cards.

As indicated at bock 2316, the method may include defining one or more post-withdrawal scenarios to allow the player the ability to continue playing the folded hand. For example, side-game application 160 (FIG. 1) may determine one or more post-withdrawal scenarios, which may benefit the folded hand of player 102 (FIG. 1), if player 102 (FIG. 1) has not folded the hand.

In one example, the player cards may include an eight of hearts and an ace of hearts, and the community cards may include a nine of hearts, a ten of spades and a six of hearts. According to this example, side-game application 160 (FIG. 1) may automatically determine that the player's folded hand may have been the basis for a flush, if the community cards dealt at the turn and/or river rounds would include a “heart”; and/or that the player's folded hand may have been the basis for a straight, if the community cards dealt at the turn and/or river rounds would include a “seven”. Accordingly, application 160 (FIG. 1) may automatically define at least a first after-fold scenario having a winning criterion requiring a heart; and a second after-fold scenario having a winning criterion requiring a seven.

As indicated at block 2318, the method may include determining one or more reward-ratios corresponding to the one or more insurance scenarios. For example, scenario definer 161 (FIG. 1) may provide reward-ratio definer 163 (FIG. 1) with information regarding the known cards, and the potential cards, which may result in the post-withdrawal scenarios. In the above-described example, the potential cards may include any “heart” card relating to the first post-withdrawal scenario, and the card “seven” relating to the second post-withdrawal scenario.

As indicated at block 2320, the method may include offering to the player the one or more post-withdrawal scenarios. For example, side-game application 160 (FIG. 1) may provide player 102 (FIG. 1), e.g., via interface 110 (FIG. 1) with two side bet after-fold lines, including a first line requiring the appearance of an additional heart-shaped card, and a second line requiring the appearance of a seven. In this example, player 102 (FIG. 1) may be provided with two insurance lines, however it will be appreciated that any other number of insurance lines may be offered to player 102 (FIG. 1).

In some embodiments, the player may be provided with an option to choose a round in the game until which the player wants to wager the post-withdrawal scenario, and the calculation of the reward-ratio and/or a price of the wager to be placed on the post-withdrawal line may be determined by reward-ratio definer 163 (FIG. 1) according to the selected round, e.g., as described below with reference to FIG. 25.

As indicated at block 2322, the method may include repeating the operations of blocks 23216, 2318 and 2320 for one or more additional insurance scenarios.

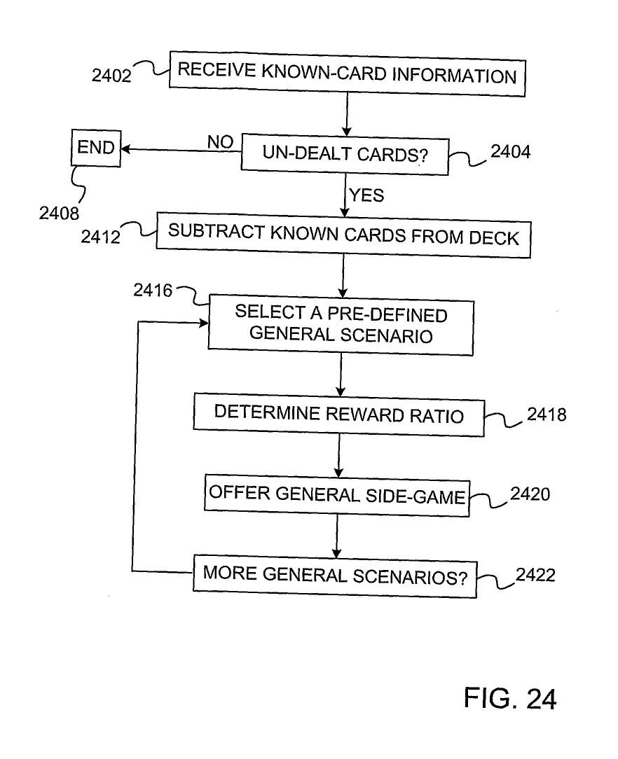

Reference is made to FIG. 24, which schematically illustrates a method of determining one or more general side-game scenarios, in accordance with some demonstrative embodiments. In some embodiments, one or more operations of the method of FIG. 24 may be implemented by side-game application 160 (FIG. 1) for example, to determine and offer one or more general side-game scenarios to player 102 (FIG. 1) of an online Texas Hold'em poker game provided by service 140 (FIG. 1).

As indicated at block 2402, the method may include receiving known-card information representing player cards and any already-dealt community cards. For example, the known-card information may include two player cards, if the known-card information is received at the pre-flop round; the two player cards and three community cards, if the known-card information is received at the flop round; or the two player cards and four community cards, if the known-card information is received at the turn round.

As indicated at block 2404, the method may include determining whether or not there are any un-dealt cards to be dealt, e.g., by determining whether or not the number of known cards is equal to or less than seven.

As indicated at block 2408, the method may include completing without returning any scenario, if there are no un-dealt cards to be dealt, e.g., if all seven cards have been dealt.

As indicated at block 2412, the method may include subtracting the known cards from a full deck of cards to determine the unknown cards. For example, at the pre-flop round the set of potential cards may include fifty cards remaining after subtracting the two player cards from a full deck of 52 cards; at the flop round the set of potential cards may include forty seven cards remaining after subtracting the two player cards and the three community cards from the full deck of 52 cards; and at the turn round the set of potential cards may include forty six cards remaining after subtracting the two player cards and the four community cards from the full deck of 52 cards.

As indicated at block 2416, the method may include selecting a predefined general side-game scenario. For example, side-game application 160 (FIG. 1) may maintain, e.g., in the form of a suitable table or array, one or more predefined general side-game scenarios relating to combinations of one or more un-dealt community cards, which may be offered to player 102 (FIG. 1). The predefined general side-game scenarios may include, for example, but not limited, to one or more of a red card being dealt; a black card being dealt; a certain shape, e.g. heart, spade, club or diamond being dealt; a card greater than a predefined value, e.g., greater than five, being dealt; a card lesser than a predefined value, e.g., lesser than five, being dealt; a predefined combination of cards, e.g., a “black jack” combination, being dealt; and/or any other suitable combination or scenario.

As indicated at block 2418, the method may include determining a reward-ratio corresponding to the selected general side-game scenario. For example, scenario definer 161 (FIG. 1) may provide reward-ratio definer 163 (FIG. 1) with information regarding the known cards, and the potential cards required by the general scenario.

As indicated at block 2420, the method may include offering to the player the one or more general side-game scenarios. For example, side-game application 160 (FIG. 1) may provide player 102 (FIG. 1), e.g., via interface 110 (FIG. 1) with a general side-game scenario.

In some embodiments, the player may be provided with an option to choose a round in the game until which the player wants to wager the general side-game scenario, and the calculation of the reward-ratio and/or a price of the wager to be placed on the general line may be determined by reward-ratio definer 163 (FIG. 1) according to the selected round, e.g., as described below with reference to FIG. 25.

As indicated at block 2422, the method may include repeating the operations of blocks 24216, 2418 and 2420 for one or more additional insurance scenarios.

In some embodiments, although the general side-game scenarios are predefined, the reward-ratios corresponding to the general side-game scenarios are player-specific, as application 160 (FIG. 1) may determine the reward ratio relative to the community cards and the player cards held by player 102 (FIG. 1), thereby affecting the winning ratio significantly.

In one example, a first player may hold two red cards, while a second player may hold two black cards. The general side-game scenario may include a winning criterion requiring that all community cards in the flop round are red, e.g., hearts, diamonds or a combination thereof. Different reward ratios may be determined by application 160 (FIG. 1) corresponding to the first and second players. For example, application 160 (FIG. 1) may provide the first player with the general side-game scenario having a reward-ratio based on a statistic equilibrium of 9.68, while the second player may be provided with a winning ratio based on a statistic equilibrium of 7.53. It is noted, that although the two players are observing the same general side-game scenario the two players are provided with different reward ratios. The first player receives a reward ratio, which is, for example, 28% greater than the reward ratio of the second player, since the conditional probability that a red card will appear, knowing that two red cards have been dealt from the deck, is lesser than the conditional probability that a red card will appear, knowing that two black cards have been dealt from the deck.

In another example, a first player may hold an ace of spades and a king of hearts, while a second player may hold a ten of diamonds and a ten of hearts. The community cards may include a jack of hearts a two of hearts and a seven of spades. The general side-game scenario may include a winning criterion requiring that a card equal or greater to a queen will appear in the community cards. Different reward ratios may be determined by application 160 (FIG. 1) corresponding to the first and second players. For example, application 160 (FIG. 1) may provide the first player with the general side-game scenario having a reward-ratio based on a statistic equilibrium of 4.7, while the second player may be provided with a winning ratio based on a statistic equilibrium of 3.9. It is noted, that although the two players are observing the same general side-game scenario the two players are provided with different reward ratios. The first player receives a reward ratio, which is, for example, 20%, greater than the reward ratio of the second player, since the conditional probability that a card equal or greater to a queen will appear, knowing that an ace of spades and a king of hearts have been dealt from the deck, is lesser than the conditional probability that a card equal or greater to a queen will appear, knowing that a ten of diamonds and a ten of hearts have been dealt from the deck.

Reference is now made to FIG. 25, which schematically illustrates a method of determining a winning ratio corresponding to a side-game scenario, in accordance with some demonstrative embodiments. In some embodiments, one or more operations of the method of FIG. 25 may be implemented by side-game application 160 (FIG. 1) for example, to determine and offer one or more side-game scenarios to player 102 (FIG. 1) of an online Texas Hold'em poker game provided by service 140 (FIG. 1).

As indicated at block 2502, the method may include receiving scenario information defining the side-game scenario. For example, reward-ratio definer 163 (FIG. 1) may receive the scenario information from scenario definer 161 (FIG. 1). The scenario information may include, for example, a definition of a round in the game, e.g., pre-flop, flop, or turn, in which the side-game scenario is to be offered; a definition of a round in the game, e.g., flop, turn or river, until which the side-game scenario is to be offered; a type of the side-game scenario, e.g., insurance, post-withdrawal or general; the known card information defining the known cards, e.g., as described above; the un-known card information, e.g., as described above; the winning criterion defined by the side-game scenario, e.g., the identity of the one or more cards required by the winning criterion.

As indicated at block 2504, the method may include selecting a statistic calculation scheme to be applied for determining the reward ratio corresponding to the side-game scenario. For example, reward-ratio definer 163 (FIG. 1) may an array of statistical equations and/or combinatorics, which are capable of calculating statistical occurrences in the poker space or in a more coherent space of a card deck including 52 cards.

In some embodiments, reward-ratio definer 163 (FIG. 1) may select the statistic calculation scheme based on the type of the side-game scenario and the game round in which the side-game scenario is offered. For example, reward-ratio definer 163 (FIG. 1) may select one of the following nine statistic calculation schemes corresponding to nine respective available combinations of the type of the scenario and the stage at which the scenario is offered:

Insurance-Pre Flop;

Insurance-Flop;

Insurance-Turn;

Fold-Pre Flop;

Fold-Flop;

Fold-Turn;

General-Pre Flop;

General-Flop; and

General-Turn.

As indicated at block 2506, the method may include determining the reward ratio based on the selected statistic calculation scheme. For example, reward-ratio definer 163 (FIG. 1) may apply the selected statistic calculation scheme to the one or more required cards of the winning criterion defined by the side-game scenario. Determining the reward ratio may include, for example, determining a statistic equilibrium value corresponding to the scenario and determining the reward ratio based on the statistic equilibrium value, e.g., taking into account a suitable “casino advantage” premium, and the like.

In a first example, the scenario information may identify the player cards include an ace of spades and a king of spades; the community cards include an ace of hearts, a ten of clubs, and a three of hearts; and the side-game scenario may include an insurance scenario having a wining criterion requiring a heart to appear in the community cards until the turn round. Accordingly, reward-ratio definer 163 (FIG. 1) may automatically select the insurance-flop statistic calculation scheme, and determine a statistic equilibrium of 0.23404.

In a second example, the scenario information may identify the player cards include an ace of spades and a king of hearts; the community cards include an ace of hearts, a ten of clubs, and a three of hearts; and the side-game scenario may include an insurance scenario having a wining criterion requiring a heart to appear in the community cards until the turn round. Accordingly, reward-ratio definer 163 (FIG. 1) may automatically select the insurance-flop statistic calculation scheme, and determine a statistic equilibrium of 0.21276. It is noted, that despite the fact that these two examples are almost identical (in the first example the player holds a king of spades, while in the second example the player holds a King of hearts, reward-ratio definer 163 (FIG. 1) may determine a different equilibrium, and thus different reward ratios, since the statistic equilibrium may be affected by the known cards, which include the player cards.

In a third example, the scenario information may identify the player cards include an ace of spades and a king of hearts; the community cards include an ace of hearts, a ten of clubs, and a three of hearts; and the side-game scenario may include an insurance scenario having a wining criterion requiring a heart to appear in the community cards until the river round. Accordingly, reward-ratio definer 163 (FIG. 1) may automatically select the insurance-flop statistic calculation scheme, and determine a statistic equilibrium of 0.38390. It is noted, that a relatively large difference in the statistical equilibrium may result from changing the stage until which the insurance scenario is provided to the player.

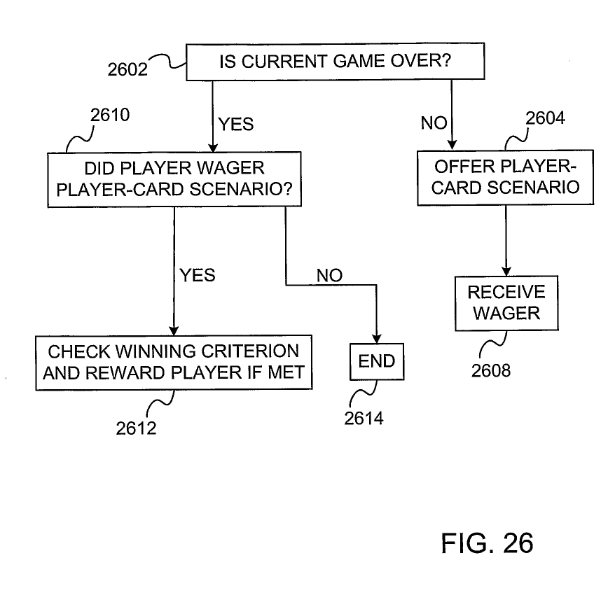

Reference is now made to FIG. 26, which schematically illustrates a method of offering a player-card side-game scenario, in accordance with some demonstrative embodiments. In some embodiments, one or more operations of the method of FIG. 26 may be implemented by side-game application 160 (FIG. 1) for example, to determine and offer one or more player-card side-game scenarios to player 102 (FIG. 1) of an online Texas Hold'em poker game provided by service 140 (FIG. 1).

As indicated at block 2602, may include determining whether or not a current game has ended. For example, side-game application 160 (FIG. 1) may determine whether or not the current game has ended.

As indicated at block 2604, the method may include offering the player one or more player-card side game scenarios relating to the player cards to be dealt to the player in a next game, e.g., if the current game has not yet ended and/or as long as the player cards of the next game have not yet been dealt to the player.

As indicated at block 2608, the method may include receiving one or more wagers from the player on the one or more player-card side game scenarios, respectively.

As indicated at block 2610, if the current game has ended, the method may include determining, prior to dealing to the player the player cards of a next game, whether or not the player has already wagered at least one player-card scenario relating to the player cards to be dealt to the player at the next game.

As indicated at block 2614, the method may include completing without performing any additional operation, e.g., if the player has not wagered the player cards of the next game.

As indicated at block 2612, if the player has placed a wager on at least one player-card scenario, the method may include determining whether or not the player cards dealt to the player in the next game meet the winning criterion of the wagered scenario. The method may also include rewarding the player based on the reward ratio defined by the wagered scenario, if the winning criterion is met.

In some embodiments, side-game application 160 (FIG. 1) may be capable of determining whether or not the winning criterion of the wagered player-card scenario is met during the pre-flop round of the next game. Side-game application 160 (FIG. 1) also provide the player with an option to place a wager on a player-card scenario relating to the player cards to be dealt in the next game, e.g., at any suitable round of the current game.

Although some embodiments are described herein with reference to the Texas-Hold'em Poker card game it will be appreciated that other embodiments may be similarly implemented with relation to any other suitable poker card game.

Although some embodiments are described herein with reference to a poker card game it will be appreciated that other embodiments may be similarly implemented with relation to any other suitable card game.

Some embodiments, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of embodiments of the invention have been illustrated and described herein, many modifications, substitutions, changes, and equivalents may occur to those skilled in the art. It is, therefore, to be understood that the appended claims are intended to cover all such modifications and changes.

1. A system comprising:
a memory having stored thereon side-game application instructions; and
a processor to execute the side-game application instructions resulting in a side-game application corresponding to an online indicia-based game, the indicia-based game including dealing a first number, equal to or greater than one, of player indicia to each of one or more players and dealing a second number, equal to or greater than one, of community indicia revealed to all of the players,
wherein the side-game application is to receive player-indicia information representing player indicia already dealt to a player of the players, prior to the dealing of at least one un-dealt indicia, wherein the at least one un-dealt indicia includes at least one of a player indicia to be dealt to the player and a community indicia to be revealed to the players,
wherein, based at least on the player-indicia information, the side-game application is to automatically determine one or more player-specific side-game scenarios, each defining a winning criterion relating to one or more of the un-dealt indicia, and to automatically offer to the player a side-game including the one or more player-specific side-game scenarios,
wherein the side-game application is to receive at least one wager from the player corresponding to at least one respective wagered side-game scenario of the one or more scenarios,
and wherein, upon a dealing of the un-dealt indicia of the wagered scenario, the side-game application is to automatically reward the player if the criterion corresponding to the wagered scenario is met.

2. The system of claim 1, wherein the one or more side-game scenarios include a player-specific insurance scenario, which is based on the player-specific information, and wherein the un-dealt indicia include one or more community indicia to be dealt after all the player indicia are dealt.

3. The system of claim 2, wherein the criterion of the insurance scenario requires that the un-dealt indicia, when dealt, will include indicia resulting in a first expected winning probability associated with a first combination of the player indicia and community indicia after dealing the un-dealt indicia, wherein the first expected winning probability is lesser than a second expected winning probability associated with a second combination of the player indicia and community indicia prior to dealing the un-dealt indicia.

4. The system of claim 1, wherein the one or more side-game scenarios include a post-withdrawal scenario to be automatically offered to the player if the player withdraws from the game prior to dealing the un-dealt indicia, wherein the criterion of the post-withdrawal side-game scenario relates to the one or more un-dealt indicia.

5. The system of claim 4, wherein the un-dealt indicia include one or more community indicia to be dealt after all player indicia have been dealt.

6. The system of claim 4, wherein the winning criterion of the post-withdrawal scenario requires that, after dealing the one or more un-dealt indicia, the community indicia will form together with the player indicia, a predefined winning indicia combination.

7. The system of claim 1, wherein the side-game application includes:
a scenario definer to automatically define the one or more player-specific side-game scenarios based on the player-specific information; and
a reward-ratio definer to automatically determine, based on the player-specific information, one or more player-specific reward ratios corresponding to the one or more scenarios, respectively, each reward ratio defining a ratio between the reward and the wager corresponding to the scenario,
wherein the side-game application is to automatically provide the one or more winning ratios to the player in association with the one or more scenarios, respectively, and to reward the player based on the wining ratio.

8. The system of claim 7, wherein the reward-ratio definer is to determine the reward ratio corresponding to a scenario based on an expected probability of the un-dealt indicia meeting the criterion of the scenario.

9. The system of claim 1, wherein the un-dealt indicia include only one or more community indicia to be dealt after all player indicia have been dealt.

10. The system of claim 1, wherein the indicia-based game includes a card game.

11. The system of claim 10, wherein the card game includes a poker game.

12. The system of claim 11, wherein the poker game includes a Texas hold'em poker game.

13. The system of claim 11, wherein the first number of player indicia includes at least two player cards.

14. The system of claim 11, wherein the second number of community indicia includes five community cards, which are revealed during two or more rounds.

15. A system comprising:
a memory having stored thereon side-game application instructions; and
a processor to execute the side-game application instructions resulting in a side-game application corresponding to an online indicia-based game, the indicia-based game including dealing one or more player indicia to each of one or more players,
wherein, prior to a dealing of at least one un-dealt player indicia, the side-game application is to automatically determine one or more side-game scenarios, each defining a winning criterion relating to one or more of the un-dealt player indicia, and to automatically offer to a player of the players a side-game including the one or more player-specific side-game scenarios,
wherein the side-game application is to receive at least one wager from the player corresponding to at least one respective wagered side-game scenario of the one or more scenarios,
and wherein, upon a dealing of the un-dealt indicia of the wagered scenario, the side-game application is to automatically reward the player if the criterion corresponding to the wagered scenario is met.

16. The system of claim 15, wherein the side-game application is to offer the one or more scenarios prior to dealing any player indicia.

17. The system of claim 15, wherein the indicia-based game includes a card game.

18. The system of claim 17, wherein the card game includes a poker game.

19. (canceled)

20. (canceled)

21. The system of claim 20, wherein the side-game application is to offer the one or more scenarios prior to dealing any of the two player cards, wherein the one or more scenarios include one or more respective winning combinations of the two player cards.

22. The system of claim 15, wherein the player includes a player of a currently played game, and wherein the one or more player-specific side-game scenarios relate to un-dealt player indicia to be dealt to the player in a successive game.
